(19) United States
(12) Patent Application Publication
(10) Pub. No.: US 2003/0065527 A1
(43) Pub. Date: Apr. 3, 2003

(54) Financial transfer modeling editor system and method

(75) Inventors: Raymond Yeh, Austin, TX (US); Cornelius F.X. Kenney V, Alexandria, VA (US)

Correspondence Address: Erik R. Nordstrom, FULBRIGHT & JAWORSKI L.L.P., 600 Congress Avenue, Suite 2400, Austin, TX, 78701, US

(73) Assignee: Zerotime Labs, L.L.C.

(21) Appl. No.: 10/027,788

(22) Filed: Dec. 20, 2001

Related U.S. Application Data
(60) Provisional application No. 60/325,508, filed on Sep. 28, 2001.

(51) Int. Cl. G06F 17/60

(52) U.S. Cl. 705/1; 705/35

(57) ABSTRACT

The Financial transfer modeling program of the present invention provides an easy-to-use, visible, dynamic application for modeling a set of financial transfers. The user can describe the set of financial transfers through graphical icons and simple input forms for parameters, without being concerned about how a financial transfer amount or stream of financial transfer amounts is calculated. The assumptions of the financial model are described explicitly in accessible, easily-changed graphical models, where the relationships between financial transfers are portrayed in terms of sequence, time, and flow of control. In one embodiment of the invention, a financial transfer modeling editor program is provided. When executed by a computer, the program can perform the following acts. It presents to a user one or more icon tools for creating a graphical representation of a financial transfer model. The one or more icon tools include at least one tool for generating a financial transfer activity icon instance with each instance having at least one attribute for defining an associated transaction between a payer and a payee entity. It receives commands from the user for building the graphical representation of the financial transfer model including receiving commands for (i) generating one or more financial transfer activity icon instances upon a workspace, (ii) associating at least one financial transfer transaction between a payer and a payee entity, and (iii) inter-connecting the one or more icon instances to generate the graphical financial transfer model. In response to receiving the user commands, the program defines a financial transfer model data structure that corresponds to the graphical financial transfer model.

This patent claims the benefit of, relies upon, and expressly incorporates by reference U.S. Provisional Patent App. No. 60/325,508, entitled “Financial Transfer Modeling System and Method,” filed on Sep. 28, 2001.

### TECHNICAL FIELD OF THE INVENTION

The present invention generally relates to a method and system for modeling financial systems. In particular, the present invention relates to a financial transfer modeling program for generating financial transfer models of various financial products and systems.

### BACKGROUND

For many people the attributes of financial products are mysterious. Consumers, partners, and employees of financial services companies all display a lack of understanding of the behavior and composition of financial products. Many consumers cannot describe the benefits, features, or behaviors of financial products such as mortgages and credit cards. Partners of financial services companies, e.g., realtors and mortgage brokers, have difficulty perceiving and explaining differences between financial products. Employees of financial services companies often define the same product in different terms, which results in the inability of those companies to efficiently develop, analyze and test complicated financial products.

As is the case with experts in any discipline, people who are fluent in accounting assume that others understand their tools such as accounts and calculations. However, many well-educated adults are innumerate and cannot use these accounts or calculations. Misunderstandings are common because of the gap between those who are numerate and fluent in accounting and those who are not. Many powerful tools for describing accounts and calculations are available on computers, but these tools are aimed at the frequent, fluent users, who do not always need simple, easy-to-follow representations of their financial models. The prevailing assumption is that numeracy is a prerequisite for understanding these financial models, but many of the people for whom the models are developed are not numerate. The people who build accounting tools on computers are themselves numerate and design the user interfaces for numerate people.

Computer spreadsheet applications have been the preeminent financial modeling tool for over twenty years. Unfortunately, for users unfamiliar with the conventions of accounting, spreadsheets can be unintelligible and intimidating. Even more problematic, large or complex spreadsheets can be difficult to maintain because their logic is hidden in the formulae of the cells.

Applications for electronically processing financial transfers have been developed for specific products. however, they have tended to be limited in their applicability for other products, and they require users to separately become familiar with their user interfaces and logical methodologies. Moreover, the costs and time to build these applications has stayed high or become higher.

Accordingly, what is need is an improved general scheme for modeling and analyzing financial systems and products.

### SUMMARY OF THE INVENTION

The Financial transfer modeling program of the present invention provides an easy-to-use, visible, dynamic application for modeling a set of financial transfers. The user can describe the set of financial transfers through graphical icons and simple input forms for parameters, without being concerned about how a financial transfer amount or stream of financial transfer amounts is calculated. The assumptions of the financial model are described explicitly in accessible, easily-changed graphical models, where the relationships between financial transfers are portrayed in terms of sequence, time, and flow of control. In one embodiment of the invention, a financial transfer modeling editor program is provided. When executed by a computer, the program can perform the following acts. It presents to a user one or more icon tools for creating a graphical representation of a financial transfer model. The one or more icon tools include at least one tool for generating a financial transfer activity icon instance with each instance having at least one attribute for defining an associated transaction between a payer and a payee entity. It receives commands from the user for building the graphical representation of the financial transfer model including receiving commands for (i) generating one or more financial transfer activity icon instances upon a workspace, (ii) associating at least one financial transfer transaction between a payer and a payee entity, and (iii) inter-connecting the one or more icon instances to generate the graphical financial transfer model. In response to receiving the user commands, the program defines a financial transfer model data structure that corresponds to the graphical financial transfer model.

In another embodiment, the invention provides a computer-implemented method for building a financial transfer model. The method involves presenting to a user a screen interface that has a tool pallet with one or more icon tools and a workspace for creating a graphical representation of the financial transfer model thereon. The one or more icon tools include at least one tool for generating financial transfer activity icon instances upon the workspace with each instance having at least one attribute for defining an associated transaction between a payer and a payee entity. Commands from the user are received for building, upon the workspace, the graphical representation of the financial transfer model. This includes receiving commands for generating one or more financial transfer activity icon instances upon the workspace, associating at least one financial transfer transaction between a per and a payee entity for each icon instance, and inter-connecting the one or more icon instances to generate the graphical financial transfer model. As commands are received from the user, instructions are conveyed to an application component responsive to the user commands being received. These instructions cause a financial transfer model data structure to be defined that corresponds to the financial transfer model graphical representation.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 shows an exemplary screen interface for one embodiment of a financial transfer modeling program of the present invention.

FIG. 2A is a block diagram of a computer with a financial transfer modeling program of the present invention.

FIG. 2B shows a block diagram of an object-oriented financial transfer modeling program of the present invention.

FIG. 3A shows one embodiment of a routine for a financial transfer modeling program of the present invention.

FIG. 3B shows one embodiment of a routine for processing menu/keystroke commands in a financial transfer modeling program of the present invention.

FIGS. 4A through 4N depict exemplary screen interfaces highlighting command menus for one embodiment of a financial transfer modeling program of the present invention.

FIGS. 5A through 5R depict exemplary screen interfaces highlighting icons with their associated commands for one embodiment of a financial transfer modeling program of the present invention.

FIGS. 6A through 6E show one embodiment of a completeness check routine for a financial transfer modeling program of the present invention.

FIGS. 7A through 7I diagrammatically illustrate the construction of exemplary financial transfer models in a financial transfer modeling program of the present invention.

### DETAILED DESCRIPTION

A. Overview

The defining attributes of financial products can be determined by examining the movement of money and other financial transfers, between parties to the product. While the names and descriptions of products vary, the value, price, cost, and risk of a financial product are driven by the set of financial transfers defined by the product. The present invention provides a financial transfer modeling (“FTM”) editor program that generates, responsive to user commands, dynamic financial transfer models for uniformly representing financial products such as loan, bonds, and the like. The financial transfer modeling program combines powerful technology for building dynamic models of discrete events with an efficient, graphical interface for describing financial transfer models. Users who are comfortable with graphical user interfaces on computer workstations and personal computers can learn to use the Financial Transfer Editor quickly through trial and error. Users can modify models interactively, and powerful, syntax and completeness check utilities assure that a generated financial transfer model conforms to formal, algebraic rules. An incomplete or erroneously-defined model will not pass these checkers, so the user has validation of the model. In addition, the financial transfer modeling program organizes the model in a data structure (e.g., directed graph) that makes it well suited for simulation, monitoring, and other dynamic modeling activities.

Financial transfer modeling using a financial transfer modeling program can be useful in a variety of systems including financial product development budgeting for a household, company, or project investment strategy preparation and evaluation business modeling and planning. Financial analysis, such as discounting and net present value. Potential users of the financial transfer modeling program include financial analysts, product developers, computer application developers, and auditors.

The program utilizes a graphical user interface comprising a drawing area, palettes, icons, menus, and input forms that are simple, easy to learn, easy to remember, and require limited mathematics skills. The program uses a syntax-based modeling language that defines the graphs elements in terms of a formal, algebraic language with clear rules for determining valid and invalid models and valid and invalid relationships between graphical elements. In one embodiment, through its syntax checker, the financial transfer modeling program enforces many of these rules throughout the interaction with the user by preventing invalid relationships from being defined. The program also incorporates a financial transfer formula editor utility for enabling a user to specify algorithms for calculating payment values, schedules, balance totals, and the like. It also employs a completeness checker utility that assures that a financial transfer model is correctly formed by identifying any violations of the modeling format rules.

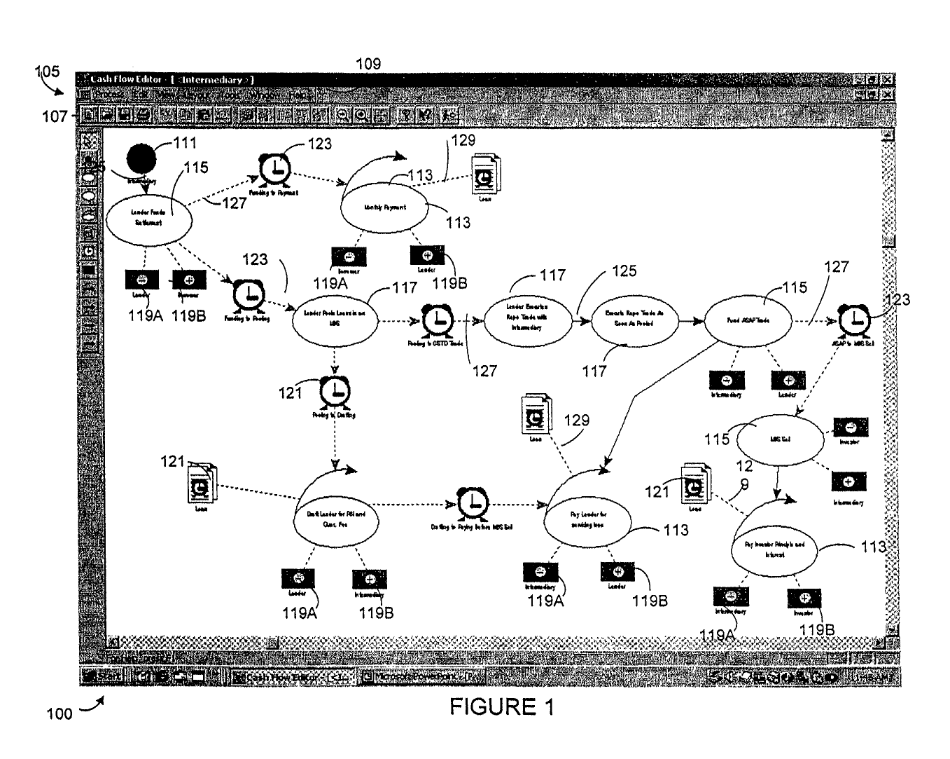

FIG. 1 shows the screen interface 100 for one embodiment of a financial transfer modeling program of the present invention. The depicted screen shows an exemplary financial transfer model 101, entitled “Intermediary,” which corresponds to a mortgage banking product. The interface has tools 105, 107 and menu commands 109 for allowing a user to create a desired financial transfer model such as the one depicted on the screen. The program provides a computer software tool that uses graphic icons 111-129 for representing the fundamental components of a financial product in terms of its financial transfers for building and efficiently modeling the product. These icons include a “start” icon 111, a recurring financial transfer activity icon 113, a non recurring financial transfer activity icon 115, a non financial transfer activity icon 117, financial transfer role icons 119 (payer 119A, payee 119B), a financial transfer activity schedule icon 121, and a time delay (or timer) icon 123. In one object oriented implementation, each icon has a corresponding predefined object from which object instances are created when a user creates a new icon instance on the screen. There are also different relationship connections including information flow connections 125, timer connections 127, association connections 129, and termination connections (not shown). Using these icons and connections (or relations), a user can create financial transfer models that describe a wide range of financial transactions such as payments, receipts, loans, investments, and trades.

The financial transfer activity icons (recurring financial transfer 113, non recurring financial transfer 115, non financial transfer 117), in cooperation with the role icons 119, provide simple, easy-to-remember shapes for efficiently representing financial transfer transactions that may be nested within larger, more complicated financial transfer products (or systems). Each account is under the control of one cash role, or entity, that appears in a financial transfer model. The financial transfer role icon serves as a graphical indicator of a logical file created and manipulated by the financial transfer model. The role icons 119 help users identify the account where a transaction originates and the account where the transaction ends without requiring knowledge of the underlying accounting procedures. For non-accountants or people working with complex financial transfer models, the financial transfer activity and role icons provide a way of efficiently conveying relevant information about a financial transfer product without overwhelming the user with complicated, convoluted graphics and excessive formulas and entries.

When two different instances of a financial transfer role icon are linked to an instance of a financial transfer activity icon, the user may define a transaction, determine the specific account for each instance of the financial transfer account icon, identify the account where the transaction originates and the account where the transaction ends, and conclude by describing how the transaction amount is to be calculated. The instance of the financial transfer role icon for the account where the transaction originates is then marked with a minus sign (role icons 119A), and the instance of the financial transfer role icon for the account where the transaction ends is marked with a plus sign (role icons 119B).

In operation, the user generally begins by launching the financial transfer modeling program, which loads the financial transfer editor drawing area and palettes. If the user is modifying an existing model, the model is retrieved from the computer hard disk storage and loaded into the financial transfer editor drawing editor. The user may choose to create a model, instead. The procedure is the same for modifying or creating a model. The user selects the icons, menus, and input screens to describe the financial transfers being modeled, and connects the activity and elated other icons using the available connectors according to the predefined rules, which are enforced by the program's syntax-based structure.

For an one-time financial transfer (non recurring), the user supplies the from account, to account, amount, and duration of the transaction. For recurring financial transfers, the user supplies the from account, to account, duration of the transaction, and the user either provides parameters for calculating the financial transfers through simple input forms or defines the formula for calculating the financial transfers through a financial transfer formula editor. If the user defines a formula through the financial transfer formula editor, the editor checks the syntax of the formula and can generate a table showing the calculated financial transfer amounts and dates.

At any time or at the end of the user session, the user may invoke the completeness checker to perform additional tests of the validity of the financial transfer model. The user may store an updated version of the current financial transfer model at any time or at the end of the session. The user may also open additional financial transfer models at any time, and the user may cut-and-paste graphical elements from one model to another. The user may opt not to store changes made to a model since the last version was stored. Likewise, the user may opt not to store a new model at all. At the end of the session, the user has the option of exiting without testing the validity of the open financial transfer model(s), but in the depicted embodiment, the user must pass a financial transfer model through the completeness checker to store a updated version of that model.

B. Financial Transfer Modeling Program

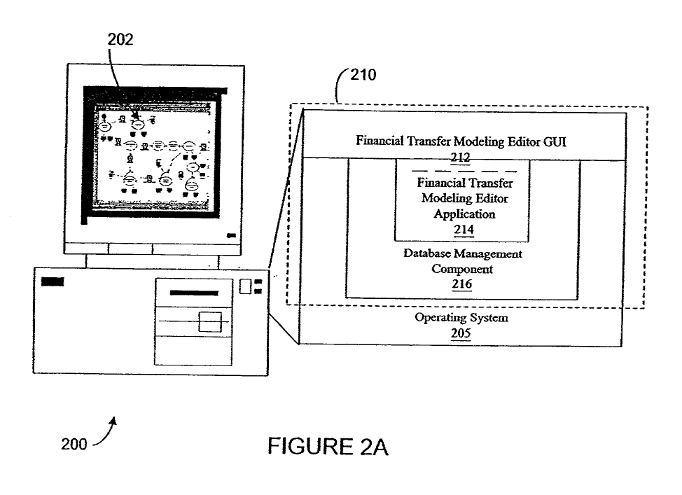

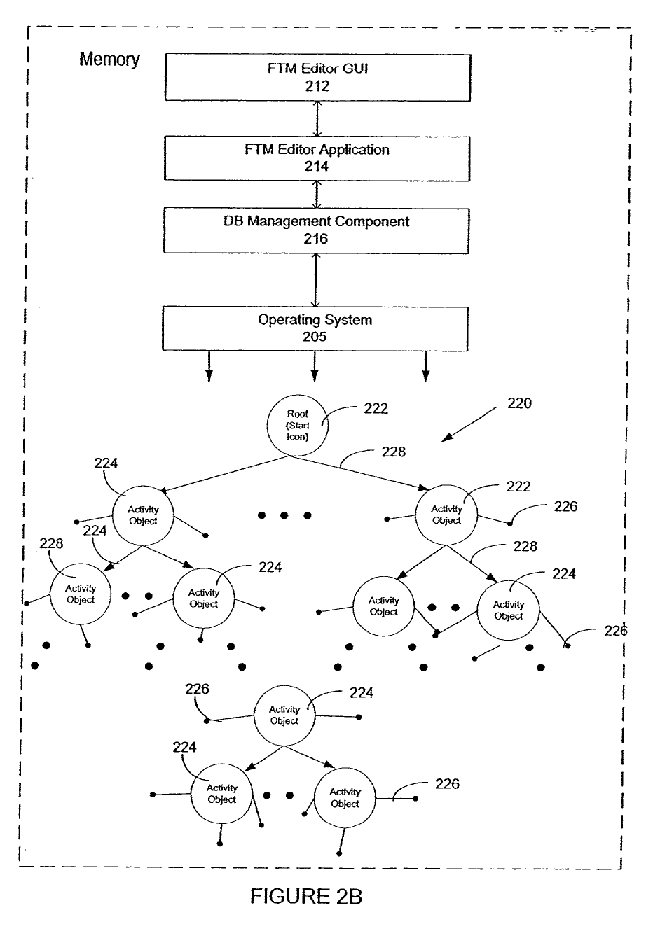

FIG. 2A shows a block diagram of one embodiment of a financial transfer modeling program 210 of the present invention. Financial transfer modeling program 210 is executed in a computer 200 with an operating system (“OS”) 205. The depicted financial transfer modeling program 210 generally includes a financial transfer modeling editor graphical user interface (“GUI”) component 212, a financial transfer modeling editor application component 214, and a database management component 216, all of which are operably linked to one another and execute within computer 200. When launched, the financial transfer modeling program 210 causes the computer to display a financial transfer editor interface screen 202. It also builds (or defines) a financial transfer model in response to commands from a user via the user interface component 212. As it is being built, a financial transfer model is both displayed on the screen, and defined in memory, e.g., as a financial transfer object model within an object container defined within database management component 216.

The computer 200 can be implemented with any suitable computer for executing the financial transfer modeling program 210. For example, it could be a personal computer, a mainframe computer, a server computer, an internet appliance executing a client-side script, and the like. Similarly, the operating system may be any suitable operating system such as a Unix, Sun Solaris, Macintosh, or Windows based operating system. In the depicted embodiment, a Windows-based personal computer is used.

The financial transfer modeling program components 212, 214 and 216 may be implemented and/or generated using any suitable programming architecture. For example, in one embodiment, an object-oriented based architecture is utilized. In this embodiment, the graphical user interface component 212 is written in C++. The financial transfer editor application component 214 is also written using a suitable scheme such as C++, but any other suitable programming language such as Java, or Cobol, could also be used. With this object oriented architecture, the database management component 216 is implemented with an object management system (e.g., object-oriented database program) such as one provided by Versant Systems™. However, depending upon the particular architecture employed, any suitable database program such as a flat file, or hierarchical database program could be utilized. With an object based modeling scheme, however, an object oriented database program is likely to be most efficient when used for saving and retrieving model instances.

FIG. 2B shows a block depiction of one embodiment of a financial transfer modeling program as implemented in memory for building a financial transfer object model 220. The financial transfer editor application component 214 contains predefined object class and attribute specifications for each financial transfer modeling program icon type. It is encoded to define the object instances in a data structure (e.g., directed graph, binary tree, linked list) that is suitable for efficiently implementing the various tools and features (syntax checker, syntax based completeness checker, simulator) either included within the program or available for use on the model. When a user initiates a command to modify the displayed financial transfer model, the user interface component 212 translates the command to the application component 214, which causes the selected object instance to either be instantiated or modified. In the depicted embodiment, the database management component 216 is used as the memory management system for storing and organizing the financial transfer model 220 in memory via the operating system 205. Database components such as object oriented database programs are typically well suited for interfacing with the operating system 205 in order to manage memory operations.

The depicted financial transfer object model 220 is defined in a directed graph data structure. It includes a root object instance 222, along with one or more activity object instances 224 with their related “children” object instances 226. The activity objects are connected to one another through a directed relationship 228. The root object 222 corresponds to the start icon 111, and the activity objects correspond to the recurring financial transfer activity icons 113, non recurring financial transfer activity icons 115, non financial transfer activity icons 117, and the timer icons 123. Similarly, the related children objects 226 correspond to the financial transfer role icons 119 (payer 119A, payee 119B) and the financial transfer schedule icons 121. They also correspond to non-icon objects that help to further define a particular activity object instance. For example, financial transfer activity objects can have related “transaction” objects that define one or more transactions associated with the activity and its associated cash roles. However, in the depicted embodiment, transaction objects are defined via the user interface through the activity icon, itself, rather than through a separate icon to be attached to the activity icon.

Timer objects are part of the related children objects 226. They have one associated parent activity object 224 and one or more children activity objects 224, which can comprise other activity objects (that are to be delayed from earlier activities) or parameter objects for defining the particular time delay parameters of the timer object. The possible relationships 228 correspond to the information flow connectors 125, timer connectors 127, association connectors 129, and termination connectors.

C. Financial Transfer Modeling Program Routine

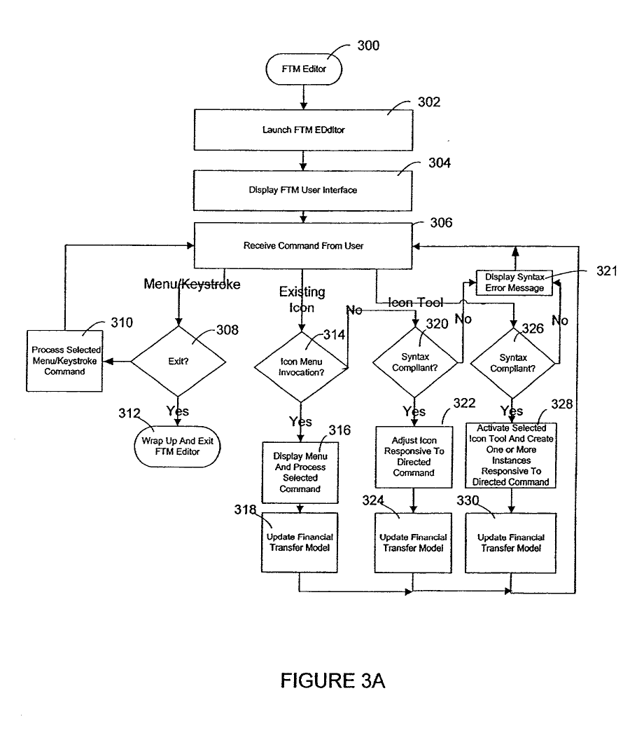

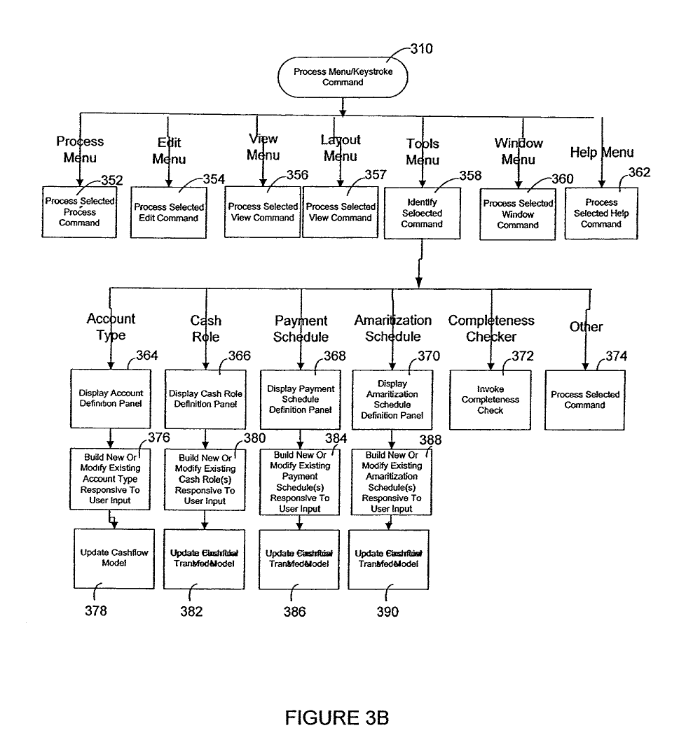

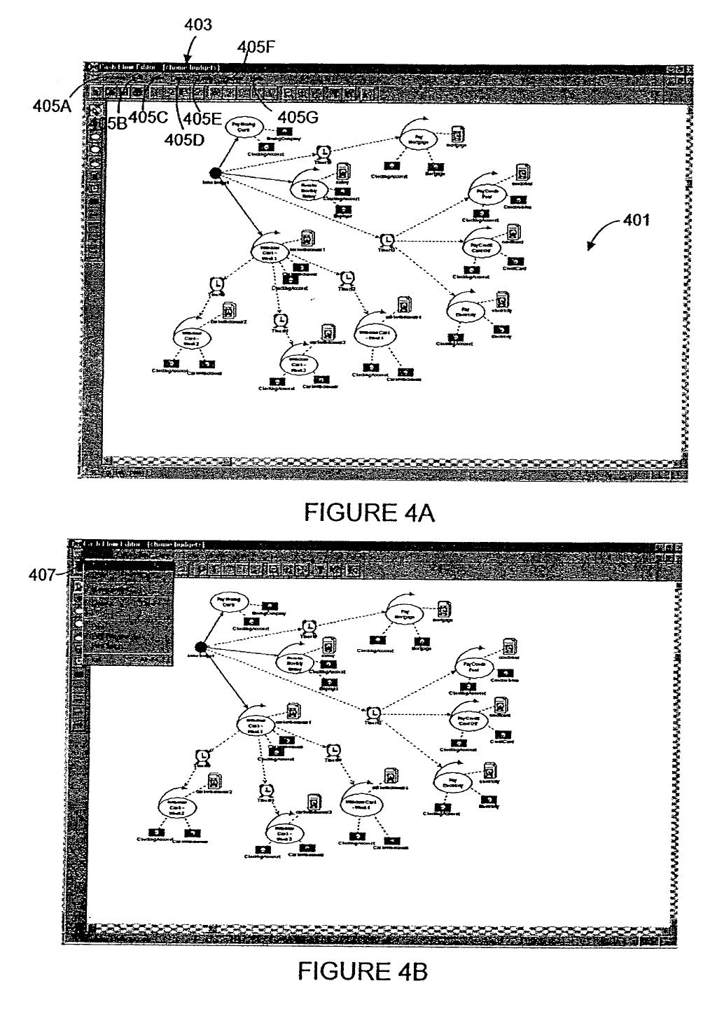

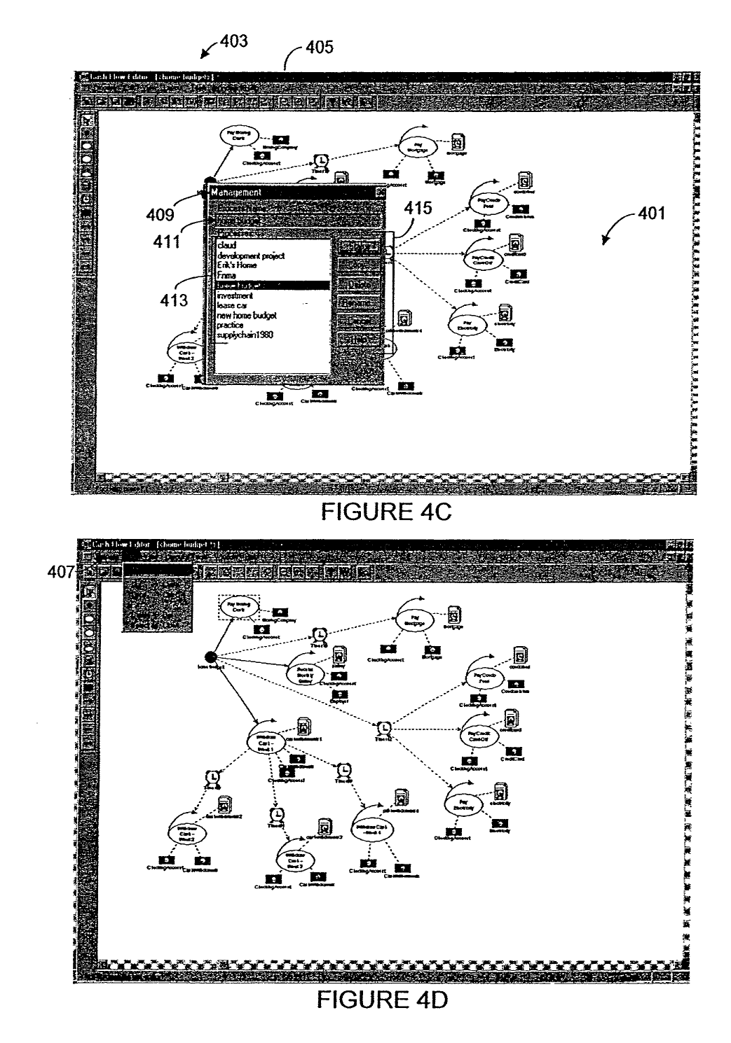

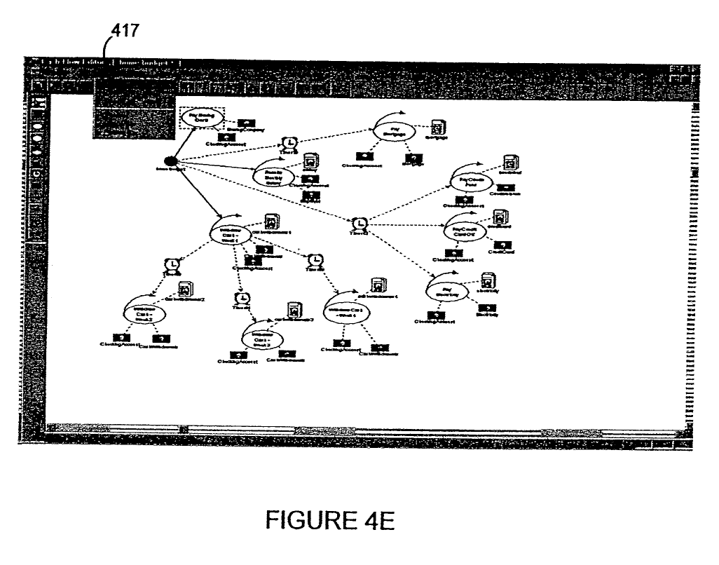

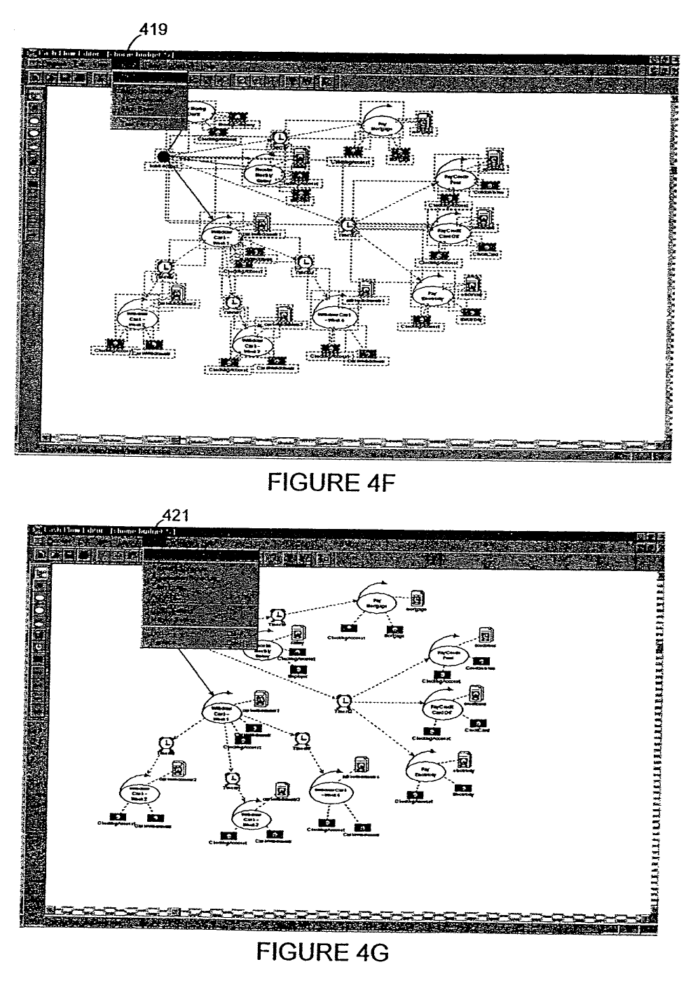

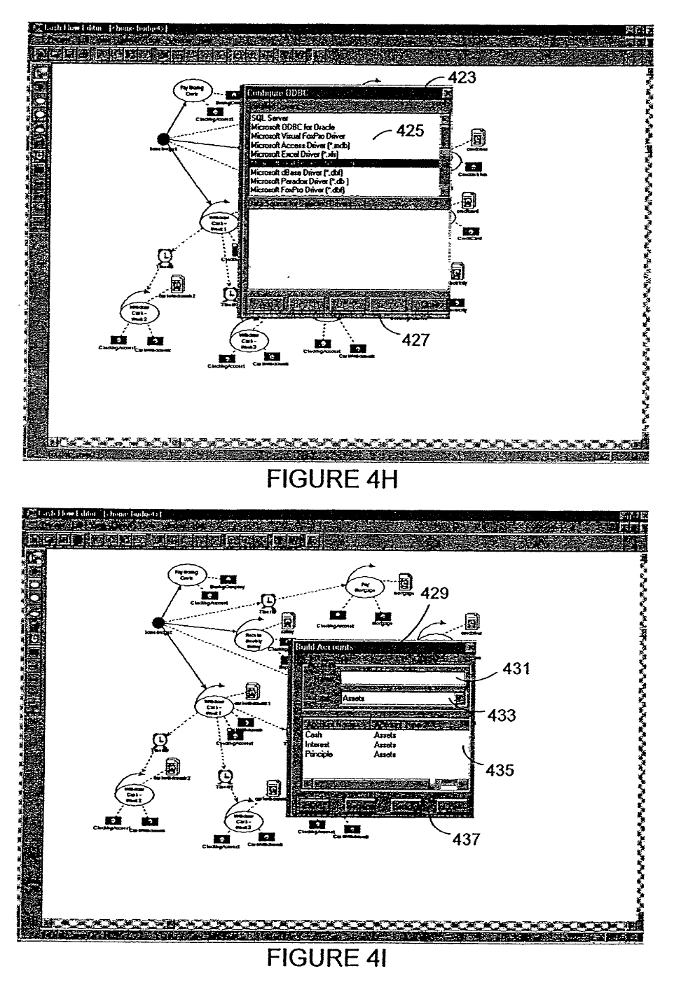

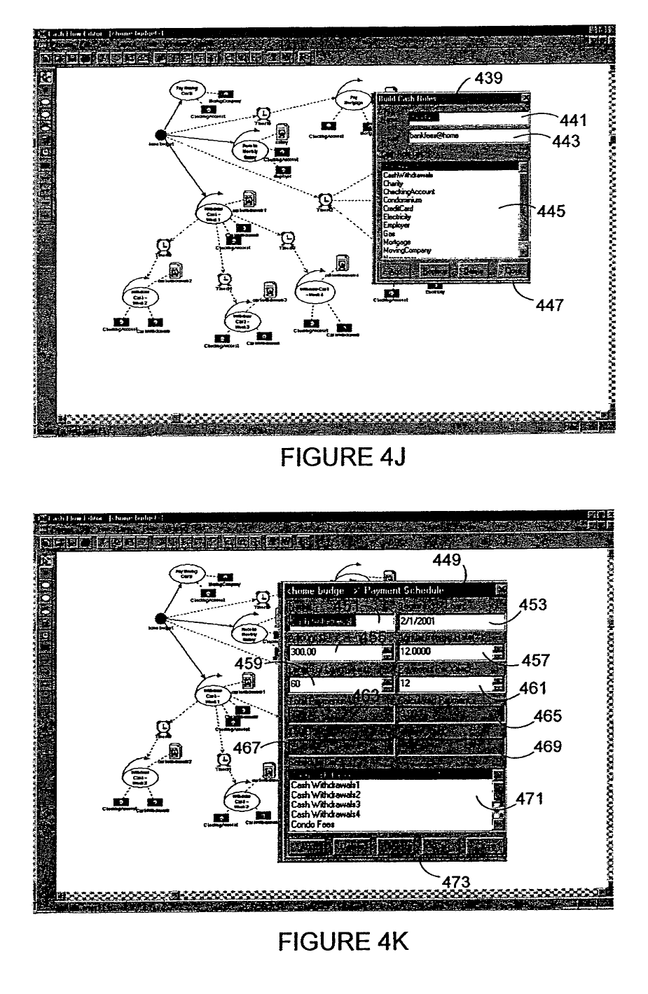

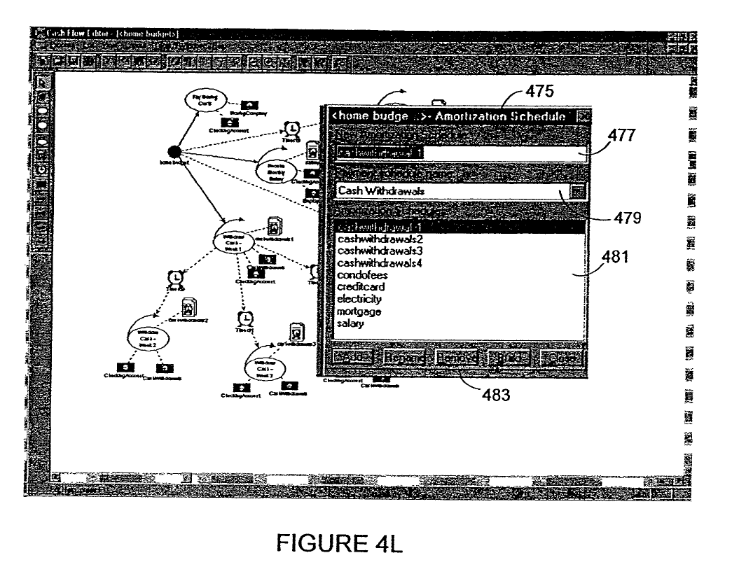

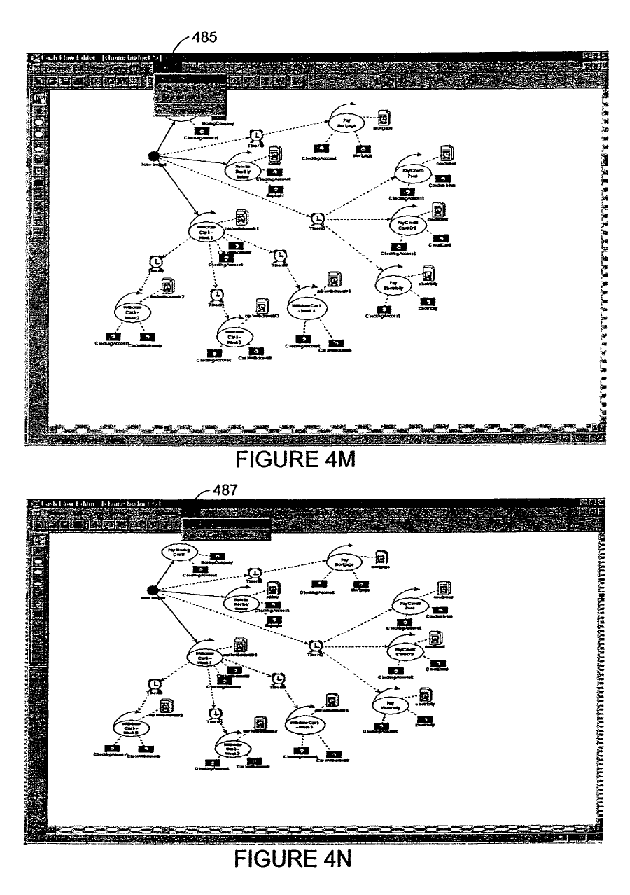

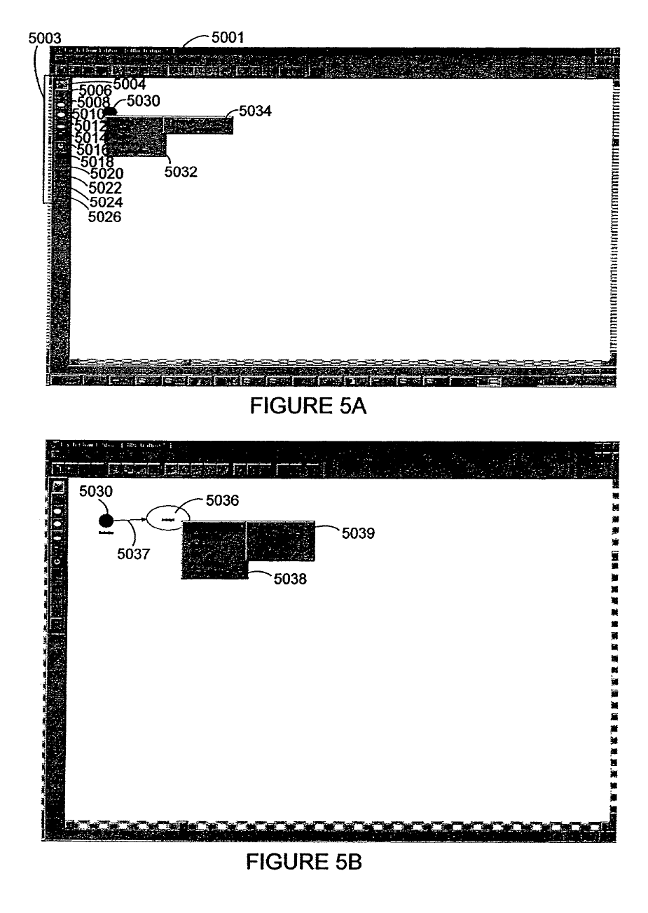

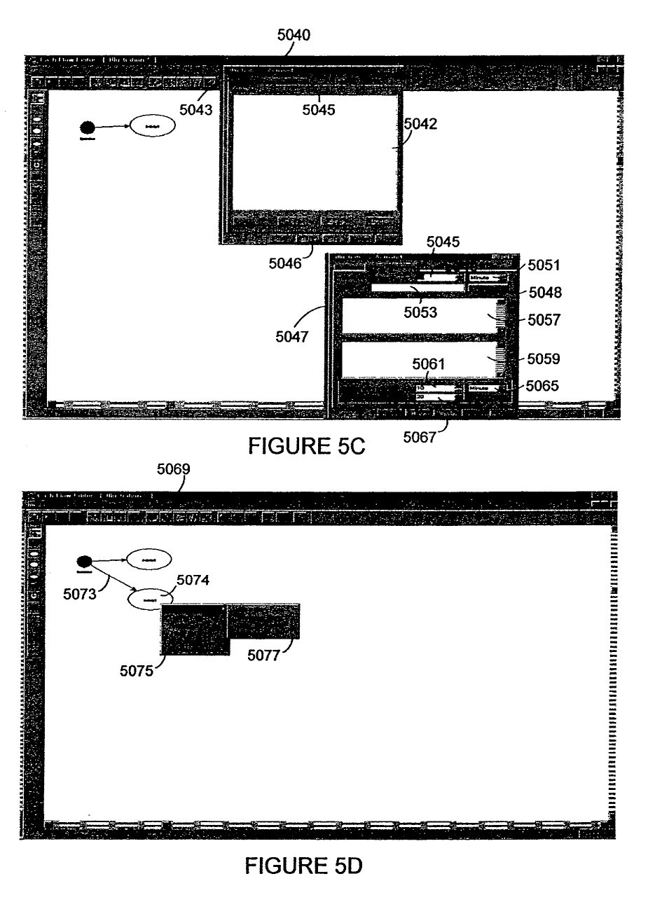

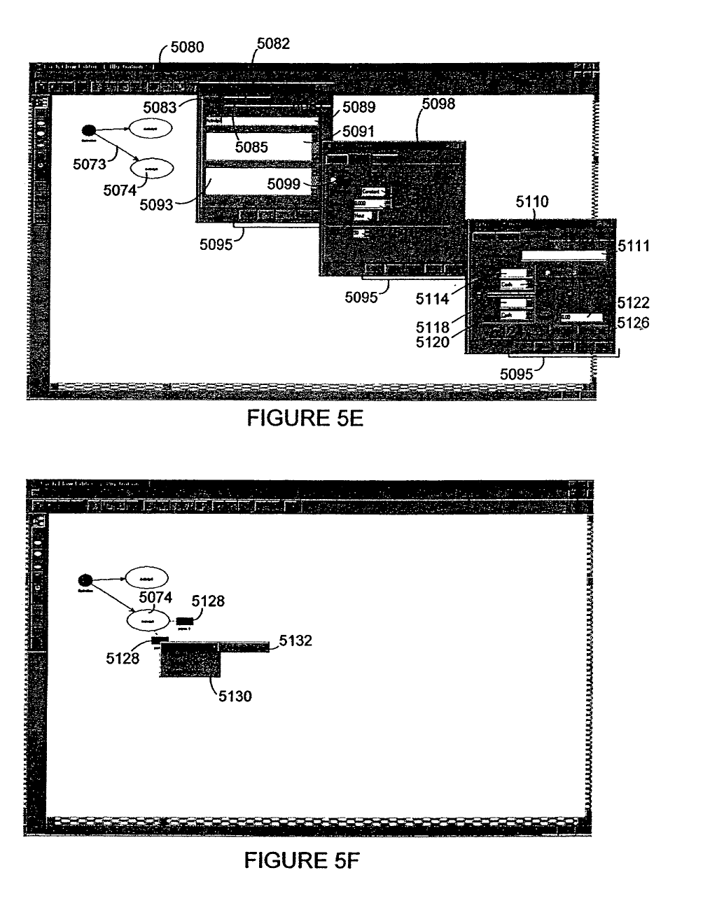

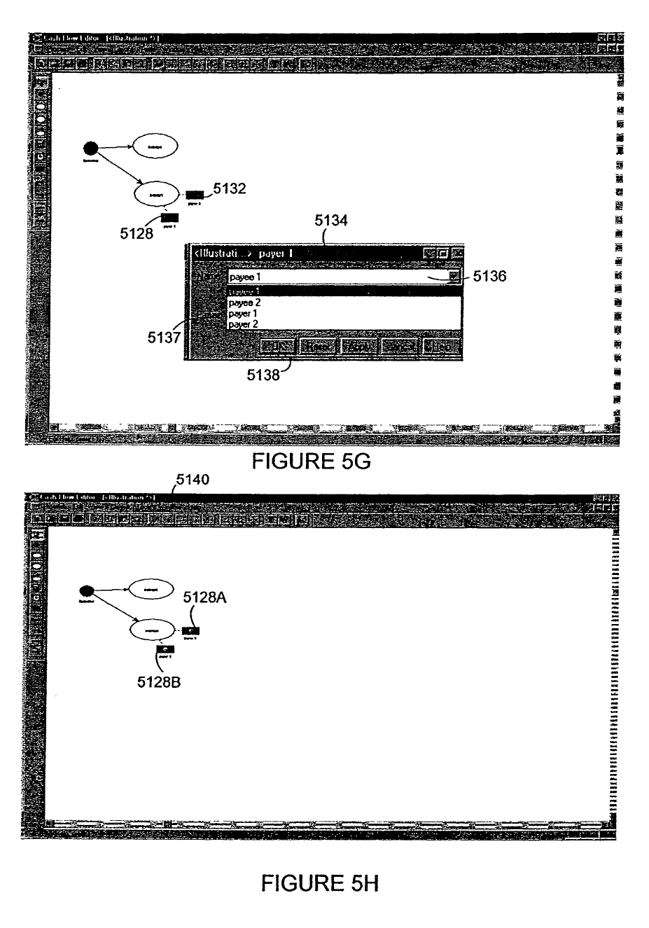

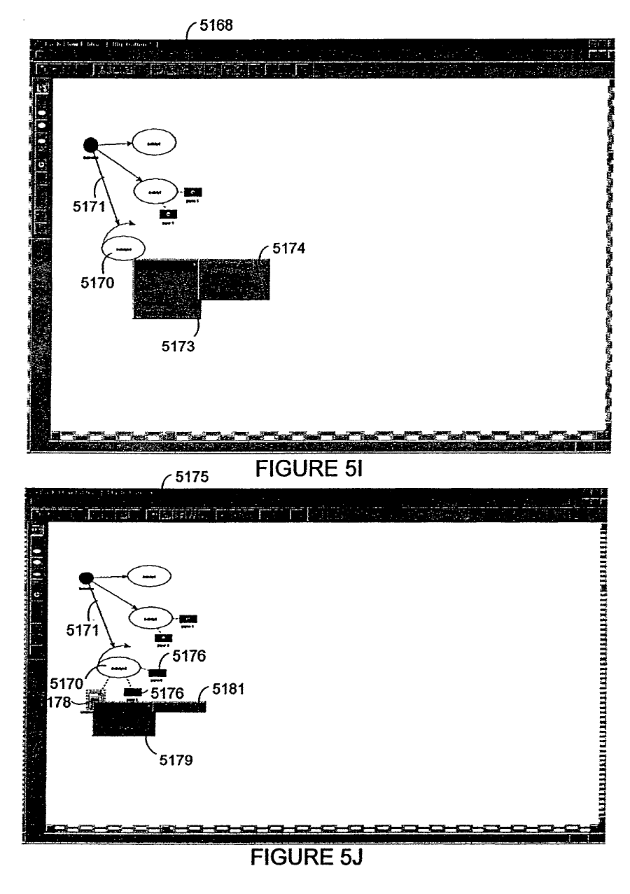

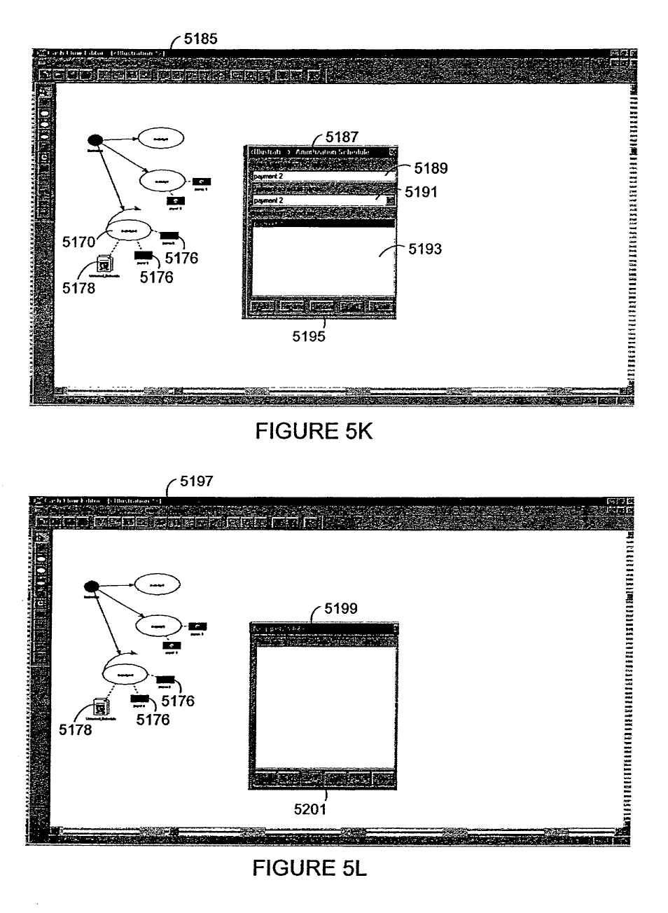

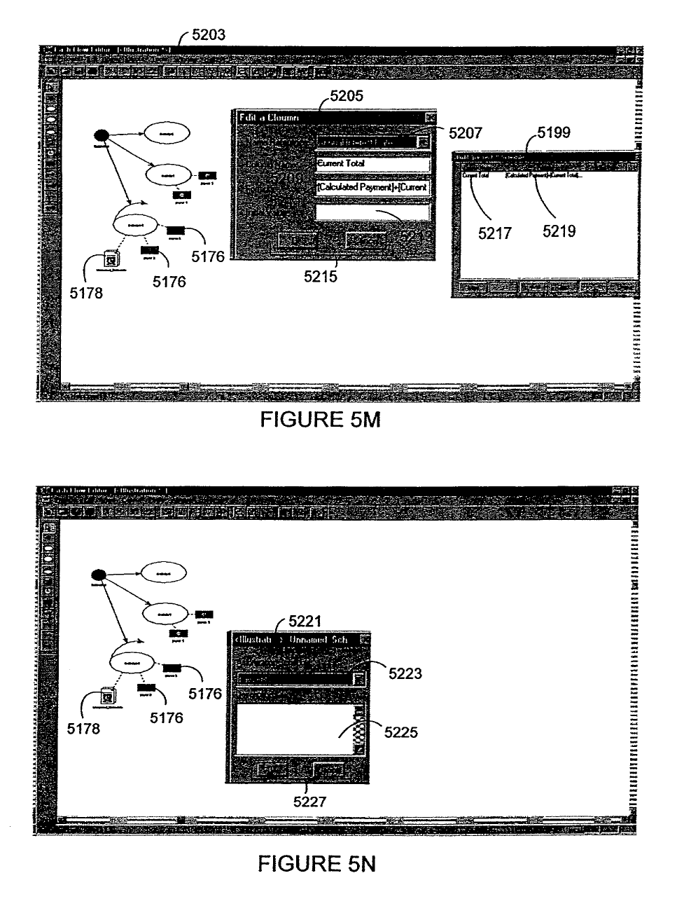

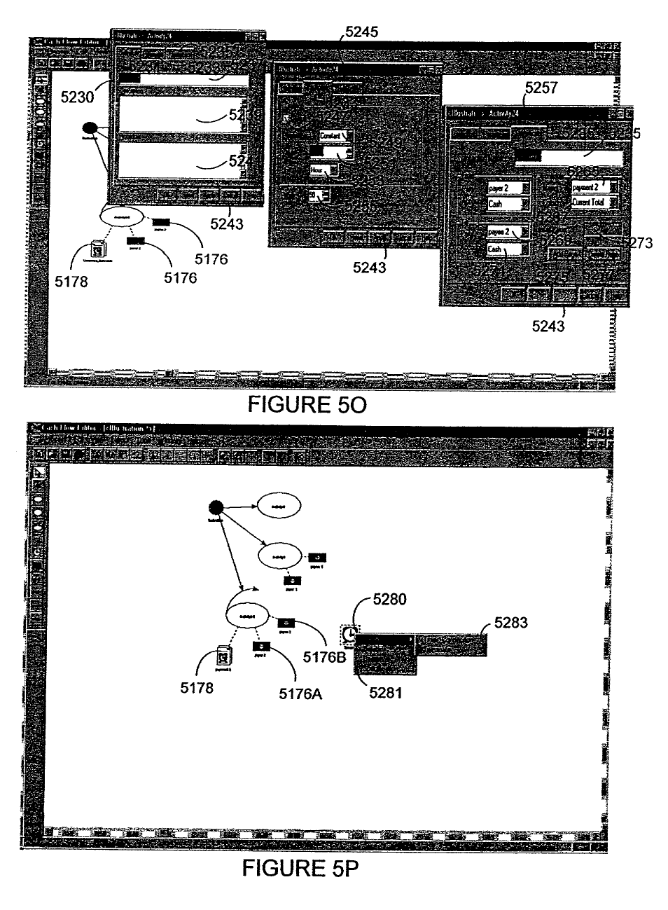

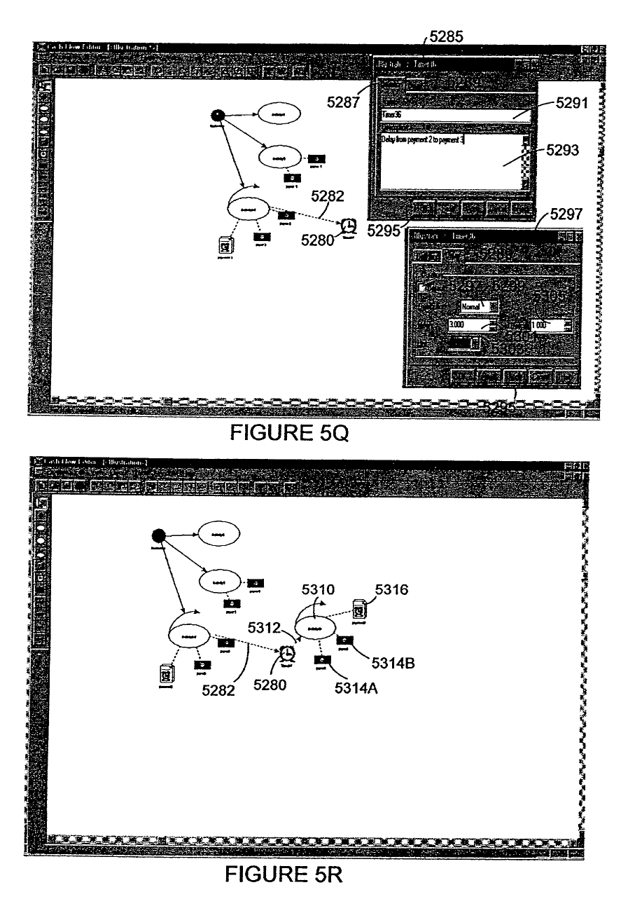

FIGS. 3A and 3B show one embodiment of a routine 300 for implementing a financial transfer modeling program of the present invention. Initially, at step 302, the program components are launched. At step 304, the graphical user interface 202 is displayed to the user. Next, at step 306, the routine receives a command from the user. In general, the command will come from the user in one of several ways, including through the menu/keyboard, an existing icon (mouse actuation, directed command) or through a tool from the tool palette. (The menu commands for one embodiment of a financial transfer modeling program are depicted in FIGS. 4A through 4N, which will be discussed in greater detail below. Similarly, the icons, tools and their associated commands for one embodiment are represented in FIGS. 5A through 5R, and will also be discussed in greater detail below.)

If a menu or keystroke command is entered by the user, then the routine at step 308 determines if the command was or was not an exit command. If it was an exit command, then the financial transfer modeling program winds up and terminates execution within the computer. Winding up can encompass various activities including but not limited to causing the created financial transfer model (or portion thereof) to be stored in non-volatile memory. On the other hand, if the menu/keyboard command is not an exit request, then the routine processes the entered command at step 310 and returns back to step 306 to receive the next command from the user. (One example of a routine for processing a selected menu/keyboard command will be discussed below with reference to FIG. 3B.)

Alternatively, if the received command is a mouse-activated command on an existing icon, then the routine proceeds to step 314, where it determines whether or not the command was an icon menu command. An icon menu command is a command (such as a right-click menu activation upon a selected icon) that causes a menu associated with the selected icon to be made available to the user. If such a menu command is invoked, then the routine proceeds to step 316, in order to display the icon menu and process the selected command.

Next, at step 318, the application updates the financial transfer model (e.g., within the object management system) if appropriate, and returns back to step 306 to process the next command received from the user. On the other hand, at determination step 314, if it was determined that the icon command was not a menu request command (i.e., it was a directed command), then the routine proceeds to step 320 and determines whether the directed command violates a syntax checking function. If it violates the syntax function, then at step 321, the routine causes an error message to be displayed through the screen interface and the program returns to step 306 to receive the next command from the user.

On the other hand, if the directed command does not violate the syntax checking function, then the routine proceeds to step 322, where it adjusts the icon in response to the directed command. A directed command is any command initiated by a user (e.g., through a mouse device, keystrokes, touch pad, or the like) that causes an icon or connection to be modified (e.g., moved, re-positioned, enlarged). Next at step 324, the financial transfer model is again updated if appropriate, and the routine proceeds back to step 306 to process the next command from the user.

If a received command is a tool palette command request, then the routine proceeds to step 326, where it determines whether the command would violate the syntax checking function. For example, the user may be attempting to use a connection tool to connect objects that are not to be connected pursuant to predefined syntax criterion. If the syntax checking function determines that the directed command is not allowed, then the routine again displays an error message at 321 and returns the user back to step 306, where it awaits the next command.

Conversely, if no syntax problems were detected, then the routine proceeds to step 328, and implements the selected icon tool command, that is, it activates the tool and creates and places one or more associated icons upon the screen work space in response to the user's directed command. Next, at step 330, the program again updates the financial transfer model within the object management system if so required. From here, the routine proceeds back to step 306 where it again awaits the next command from the user. This routine continues until it is determined at determination step 308 that the user has invoked an exit command which causes the application to exit at step 312.

1. Menu Commands

FIG. 3B shows one embodiment of a general routine for processing a menu/keyboard command at step 310 from FIG. 3A. This routine will be discussed in connection with the screens depicted in FIGS. 4A through 4N.

FIG. 4A shows a screen interface 400 with a depicted financial transfer model 401. Also shown within the screen interface is the set of command menus 405 that are available within this embodiment of a financial transfer editor interface program.

In this depicted embodiment, the user may select a command from the following menus: a process menu 405A, an edit menu 405B, a view menu 405C, a layout menu 405D, a tools menu 405E, a Windows menu 405F, and a Help menu, 405G. With reference back to the command processing routine 310 in FIG. 3B, if a user selects the process menu, then the program processes the command selected within that menu at step 352. FIG. 4B shows the process menu 407 when it is selected. The process menu is akin to a file menu in a conventional application. From top to bottom, it includes commands for creating new financial transfer processes, opening an existing financial transfer process, managing an existing financial transfer process, closing a current financial transfer process, printing a financial transfer process, and finally exiting the financial transfer process.

Most of these commands are fairly conventional and will not be discussed in greater detail. However, with reference to FIG. 4C, the management command is somewhat unique, and as such will be addressed herein. As shown in FIG. 4C, when a user selects the management command in the process menu 405A, a management window 409 appears upon the screen interface. The management window generally includes a process title field at 411, an available processes list at 413, and a set of command options at 415.

The available processes list 413 includes processes that a user may select and work upon by clicking and thereby selecting a process within the process list 413. A user can select a process that will appear in the process main field 411. With the available buttons in the set of buttons 415, a user can then act upon the selected process. In particular, the user can either check its status, copy it, delete it, rename it or simply leave the window by pressing a “cancel” button.

With reference back to FIG. 3B, if an edit menu command is selected, then the command is processed at step 354. As shown in FIG. 4D, the edit menu 405B includes conventional commands for generally editing a process file (financial transfer model) being worked upon. In particular, these commands include undo, cut, copy, delete, and select all. In this depicted embodiment, the one-time financial transfer activity titled, “Pay Moving Costs,” has been selected as indicated by the hatched box around it. Once one or more icons or connections have been selected, they may be acted upon by any of the above-referenced, conventional edit commands.

With reference back to FIG. 3B, if a view menu command is selected, the selected command is processed at step 356. As shown in FIG. 4E, the view menu 405C includes various commands for modifying the financial transfer model view presented on the screen interface. The first three commands include those for modifying the depicted financial transfer model being worked upon. These commands include center, zoom in, and zoom out. As indicated by its title, the center command allows a user to center the depicted financial transfer model. The zoom in and zoom out commands allow the user to enlarge or draw back from the depicted financial transfer model. The last three commands in the view menu 405C allow the user to adjust the command frames being displayed. These commands include toolbar, status bar, and palette bar. By selecting either of these commands, the respective command frame will be displayed to the user. As indicated in this screen, each of the command frames has been selected and therefore appears in the depicted view. The palette bar is on the left side of the screen, while the toolbar is on the top portion of the screen below the menus, and the status bar is on the lower portion of the screen.

With reference back to FIG. 3B, if a layout menu command is selected, then the command is processed at step 357. As shown in FIG. 4F, the depicted screen highlights the layout menu 405D when it is selected. The layout menu includes commands that are generally used for moving or altering the depicted financial transfer model. These commands, from top to bottom, include align horizontally, align vertically, align base, and text font. In this depiction, the entire financial transfer model has been selected, in order to make each of the layout commands visible in the layout menu. The align horizontally command aligns each of the icons along a horizontal axis. Likewise, the align vertically command aligns all selected icons along a common vertical axis. Finally, the align base aligns the base or the lowermost portion of the set of depicted icons on a screen. The text font command allows a user to modify the text appearing within a selected icon.

With reference back to FIG. 3B, if a Tool menu command is selected, then the command is identified at step 358 and processed as will be described herein. As shown in FIG. 4G, the tool menu 405E is depicted. The tool menu includes a variety of commands that are unique to the financial transfer modeling program of the present invention. These commands include a payment schedule command, an amortization schedule command, a financial transfer command, an account command, an ODBC setting command, a monitor setting command, a “find” command, and a “replace” command. The last two commands, find and replace, are actually conventional commands that may be used to find and/or replace specified text strings. The monitor setting command relates to a separate program associated with the financial transfer modeling program. With reference to FIG. 4H, the ODBC setting command, when selected causes the configure ODBC window 423 to appear. This window allows the user to select one or more drivers that may be utilized by the financial transfer modeling program. In particular, the configure ODBC window includes an installed driver list 425, that includes the specific drivers which may be activated by the program. The window also includes a field for specifying selected data sources that can be utilized by activated drivers. Finally, the ODBC window 423 includes a set of buttons 427, for either applying a new setting, removing a driver, activating a driver, or simply closing out of the window. These buttons are relatively common to many command-type windows, and need not be expounded upon in greater detail.

With reference back to FIG. 3B, if the “Account” command is selected, then the routine proceeds to step 364 and displays a build account window. From here, it builds new or modifies existing accounts based on user input at step 376. Finally, it updates the financial transfer object model if appropriate at step 378. With reference to FIG. 4I, when the account command is selected, the build account window 429 appears. This command window allows the user to specify different account types that may be used for a given process (i.e., financial transfer model). The build accounts window 429 generally includes an account name, field 431, an account type submenu 423, and an account list 435. In general, when a new process is opened, it may or may not include pre-specified account types or names. Thus, a user can create and/or designate account types that can be used for the various financial transfers within a financial transfer model to be built. In the depicted embodiment there are three account names that have been designated and are shown in List 435. These names include, cash, interest and principal, with each account being an assets-type account.

Each of these accounts or account names may be used by any of the financial transfer transactions for designated cash roles (paying or receiving parties) that will be incorporated into a given financial transfer model. Accounts can be useful in separating the different types of money that a given role may be paying or receiving in a given transaction. For example, a lender may wish to separate principal and interest in cases where these amounts can vary depending upon the rate of payment. The build accounts commandment of 429 also includes a relatively conventional set of buttons 437 for activating designated activity within the window. For example, the ad button is pressed when a user wishes to add a newly created account name. Likewise, a replace button may be used to replace a given account name with another account name. The rename button allows the user to rename a selected account name, and finally the close button allows the user to exit out of the build accounts command window 429. These command buttons are relatively conventional for command-type windows, and will not be expounded upon in great detail for this and for following command-type windows.

With reference back to FIG. 3B, if the cash role command is selected, then the routine displays the cash role designation window at step 366. From here, the routine defines new or modifies existing cash roles in response to user input at step 380. It then updates the financial transfer model, if necessary, at step 382. With reference to FIG. 4J, when the cash role command is selected, the build financial transfer command window 439 appears on the screen. The build cash role command window 439 allows the user, as the name implies, to build (or define) the different cash roles that can be utilized in a financial transfer process (or model). A cash role corresponds to person or entity that is either receiving and/or paying out something having a quantifiable value (e.g., money, debt, equity) in a transaction. Cash roles are defined in the build cash role command window, and stored within the financial transfer modeling program's object management system. It should be recognized, however that defined cash roles are not associated with a cash role icon until the user specifically activates and/or creates the icon and associates it with a specific cash role.

The build cash role window 439 generally includes a name field 441, an email address field 443, an existing cash roles list 445, and the command button set 447. When a user wishes to create a new cash role, the name for the cash role is typed in the name field 441. If the user wishes to associate an email address with that cash role, thereby allowing the entity associated with the cash role to be updated and/or reached, the user may specify the entity's email address in the email field 443. The existing cash role list 445 includes all of the preexisting cash roles already defined by the user. Each of these cash roles may later be associated with a “drag and dropped” cash role icon. In order to add a new cash role to the list of cash roles, a user types the name of the cash role in the cash role name field 441, and activates the add button within the command buttons 447. The user can also replace existing cash roles with the replace button, delete existing cash roles with the delete button, and close out of the window with the close button.

With reference back to FIG. 3B, if the payment schedule command is selected, the routine displays the payment schedule command window at 368. From here, the routine defines new or modifies existing payment schedules pursuant to input received from the user at step 384 and updates the financial transfer model, if appropriate, at step 386. With reference to FIG. 4K, the payment schedule command in menu 405E is shown with a payment schedule command window 449. The payment schedule command window 449, allows users to define one or more payment schedules to be used in financial transfer schedule icons for determining cash transactions to be transferred between different cash roles. The payment schedule command window 449 generally includes a name field 451, a beginning date field 453, an amount value field 455, an annual interest rate field 457, a length of loan field 459, a payments per year field 461, a total payments field 463, a calculated payment field 465, a total paid field 467, an interest paid field 469, a payment schedule list window 471, and a set of command buttons 473. When a user creates a payment schedule, the name of the payment schedule is typed in the name field 451. Likewise, the beginning date for the specified product name (e.g., loan, bond) is specified in the beginning of loan field 453. It should be recognized that while the window specifies “loan” as the product being implemented within a payment schedule, any product could be represented, such as loans, bonds, money markets, bill payments, and the like. The user then enters the amount for the product in the amount field 455 and inserts the annual interest rate in the annual interest rate field 457. In the depicted view, it can be seen that the user has selected a preexisting payment schedule entitled, “cash withdrawals” which appears in the name field 451. The beginning date for that payment schedule is Feb. 1, 2001. The loan amount is $300, as shown in the amount field 455, and the annual interest rate is 12 percent as shown in the interest field 457. The length of the loan in years is 60, as shown in the length of loan field 459, and the number of payments per year is 12, as shown in the payments per year field 461.

The payment schedule command window also includes a calculator tool for calculating the total number of payments, the calculated payment per month, the total interest paid and the total cash paid in full. This information is conveyed to the user in response to the user selecting the “Cal” button with a set of button commands 473, based on the information provided in the amount field 455, the annual interest rate field 457, the length of loan in years field 459, and the payments per year field 461. This calculated information is conveyed to the user in a total payments field 463, a calculated payment field 465, a total paid field 467, and an interest paid field 469.

The exemplary highlighted payment schedule, “cash withdrawals,” was a preexisting payment schedule selected from a payment schedule list 471; however, a user could create a new payment schedule simply by typing the field name in the name field 451, inserting the other relevant information in the other fields 453 through 461, and selecting or activating the add command button within the set of command buttons 473. The other command buttons include a delete button for deleting or removing a payment schedule from the list of payment schedules 467, a replace button for replacing a payment schedule with another payment schedule, and finally a close button for closing out of the payment schedule command window 449.

With reference back to FIG. 3B, if the amortization schedule command is selected, then the routine displays the amortization schedule command window at step 370. Next at step 388, the routine builds a new or modifies an existing selected amortization schedule, and updates the financial transfer model if appropriate at step 390. With reference to FIG. 4L, an amortization schedule command window 475 is shown on the screen. The amortization schedule is used to determine what money amounts from a selected payment schedule are to be transferred from one cash role to another for an associated financial transfer activity. The depicted amortization schedule window 475 includes an amortization name field 477; a payment schedule field 479; a list of available amortization schedules 481; and a set of command buttons 483, which allow a user to create and modify new or existing amortization schedules.

The user may either select a preexisting amortization schedule from the amortization schedule list field 481, or he/she may type the name of a new amortization schedule in the name field 477, select a preexisting payment schedule from the payment schedule field menu 479, and activate the add button within the set of command buttons 483. With the set of command buttons 483, a user may also rename an existing amortization schedule, remove an existing amortization schedule, build up either an existing or a new amortization schedule, or close out of the window.

The build command function button invokes a robust utility for defining money amounts that may be implemented by cash roles and activity transactions. This build utility will be discussed in greater detail below in connection with the creation of a schedule activity icon, which utilizes an amortization schedule.

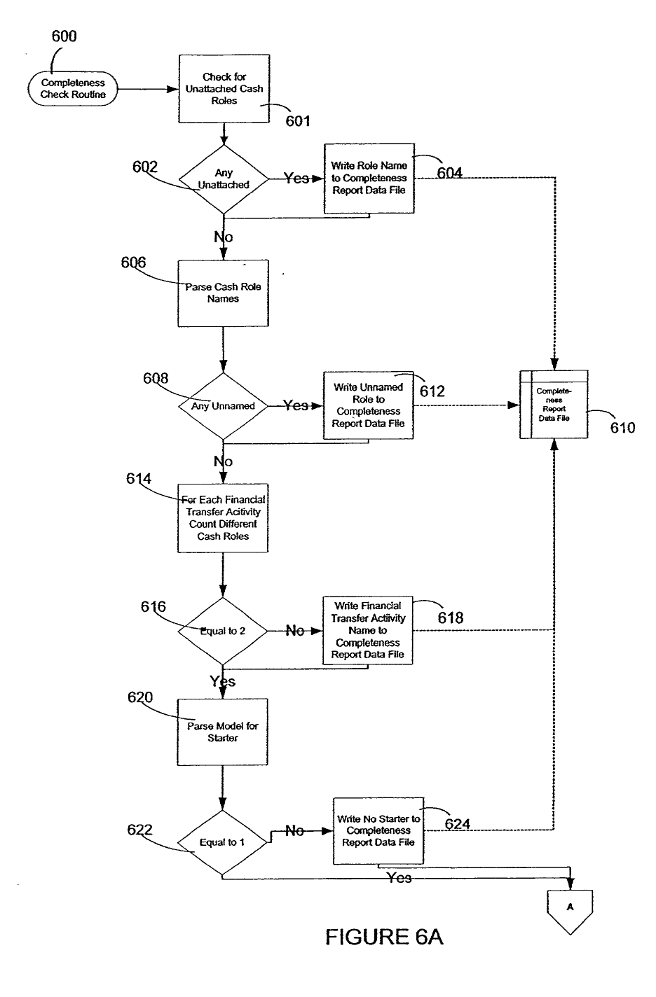

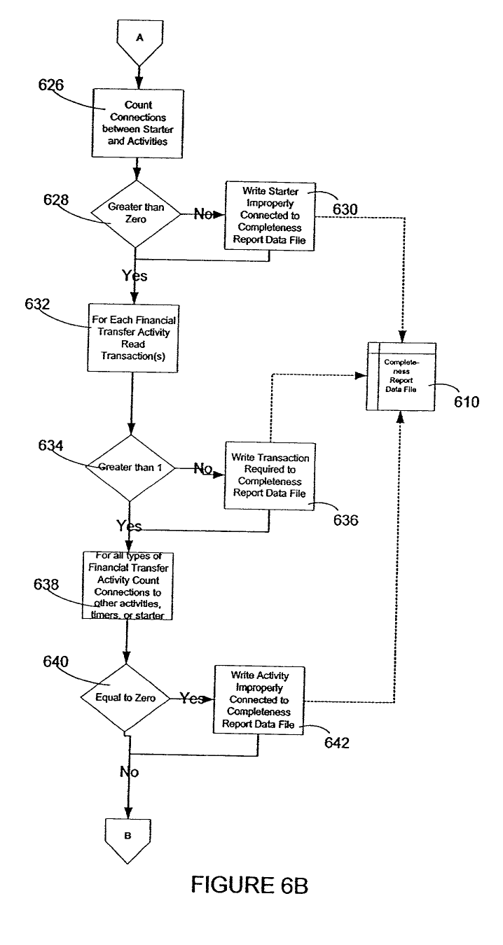

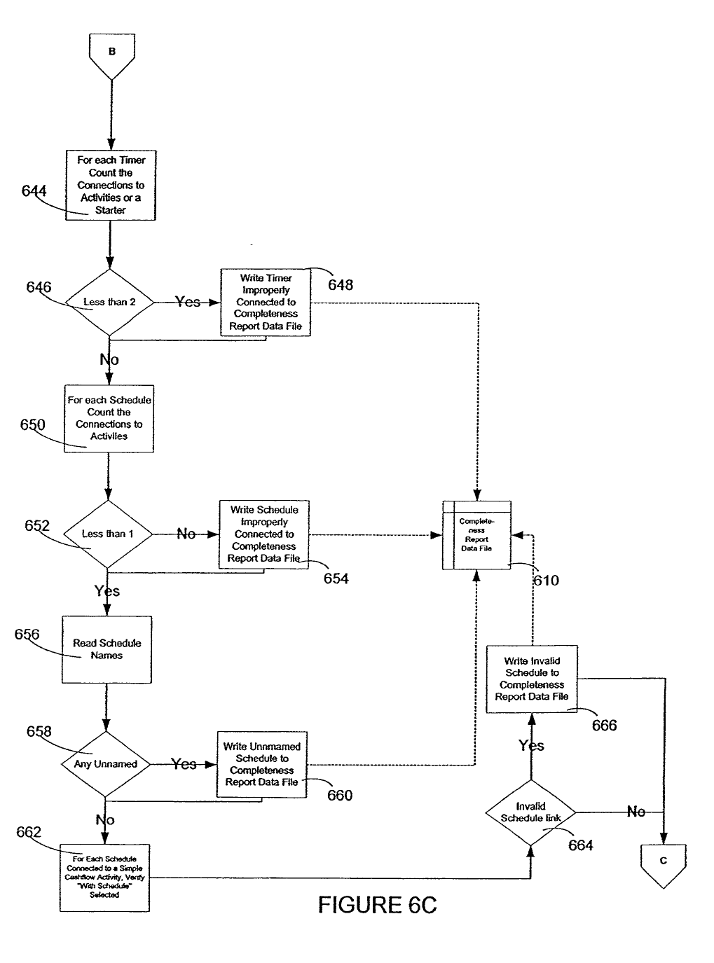

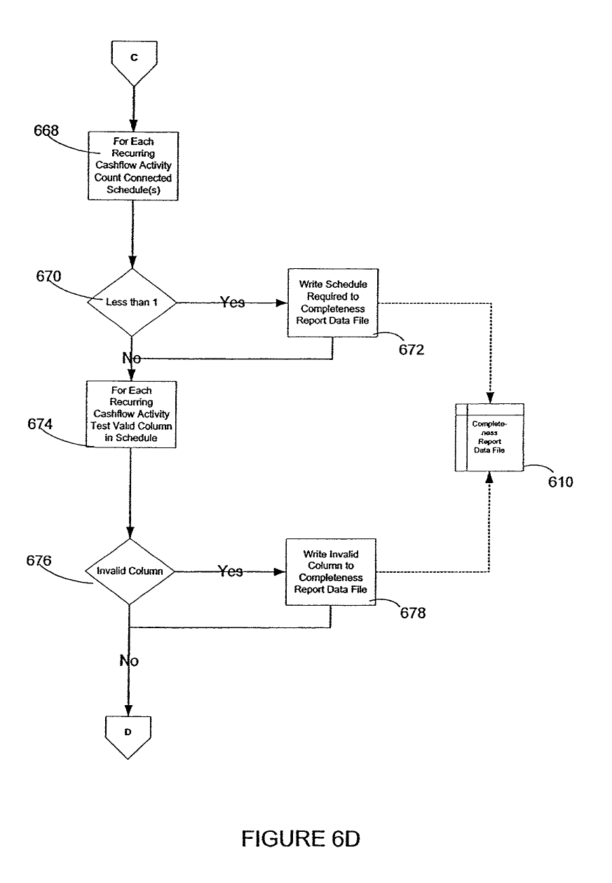

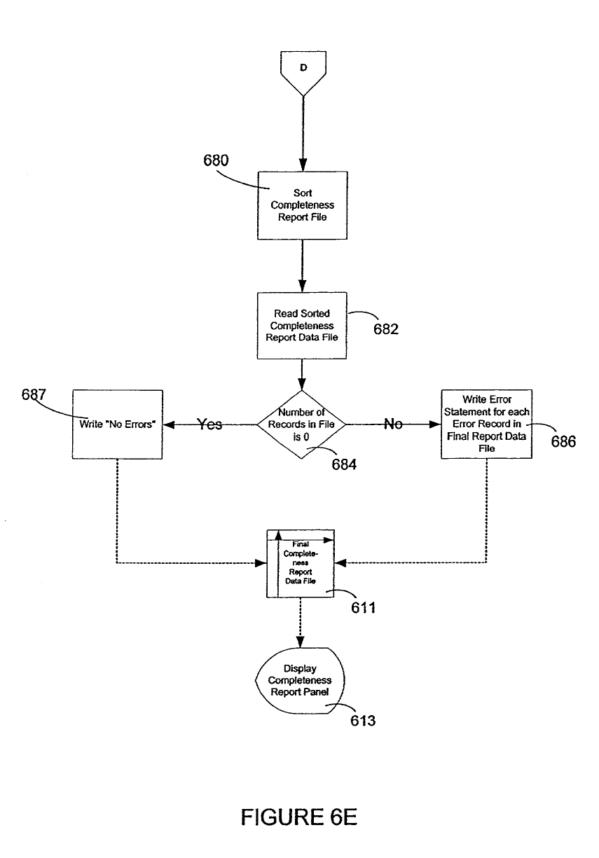

With reference back to FIG. 3B, if the completeness check command is selected, then the completeness check routine is invoked at step 372. One embodiment of a routine for implementing a completeness check routine is shown in FIGS. 6A-6E and will be addressed below. Finally, if any other tool commands are selected, they are processed at step 374.

If a window menu command is selected, the selected command is processed at step 360. FIG. 4M shows the Windows menu 405F. This menu corresponds to a conventional windows-type menu. It includes commands for determining how and what is being displayed upon the screen interface. From top to bottom, these commands include cascade, tile, and arrange icons. Below these three commands is a list of process (or financial transfer model) files that are currently open within the financial transfer modeling program. As can be seen in the depicted figure, the only open process file is home budget, which is selected and appears on the depicted screen. The cascade command allows a user to display reduced scale windows for all open financial transfer models, each occupying a portion of the screen, for easy comparison between those models. The tile command allows the user to array open models in an overlapped display that shows the selected file in front and the other open files behind with only their title bars visible. By clicking on the title bar of a financial transfer model, the user brings that model to the front, and the model that had been in front is moved behind the newly selected model, so that only its title bar is now visible now. Finally, the arrange icons command provides several utilities for more cohesively arranging the various icons within a given financial transfer model.

With reference back to FIG. 3B, if a help menu command is selected, then the command is processed at step 362. With reference to FIG. 4N, the help menu 405G is shown. The help menu is a conventional help menu that includes commands for assisting a user to better understand and/or operate the program. These two commands in the present embodiment include help topics command and about financial transfer editor command. The help topics command, when selected, causes a list of topics that may be selected by a user for providing a textual explanation of the topic to appear on the screen. The about financial transfer editor command, when selected, causes a window to appear that includes specific information about the user's version of the financial transfer modeling program.

2. Icons and Connectors

With reference to FIGS. 5A through 5R, the icon and connection tool commands will now be discussed. As depicted in FIG. 5A, the icon tool palette 5003 includes numerous tool options for creating the various icons used to create a financial transfer model. These tools include a cursor tool 5004, a start icon tool 5006, a non financial transfer activity tool 5008, a non recurring financial transfer activity icon tool 5010, a recurring financial transfer activity tool 5012, a schedule icon tool 5014, a timer icon tool 5016, a cash role icon tool 5018, an information flow connection tool 5020, a terminate or termination connection flow tool 5022, an association connection tool 5024, and a time connection tool 5026. In the depicted screen, a start icon 5030 has been deposited (“drag and dropped”) using the start icon tool 5006. Also shown is the icon command menu 5032 (along with an associated sub-menu 5034), which appear when an appropriate right-click is initiated upon the start icon 5030. The start icon corresponds to the root object of the financial transfer object model. The start icon menu 5032 includes the following commands: “create” (with sub-commands: “information flow” and “timer connection”), “delete,” “resize,” “text font,” and “specification.” The create command allows a user to cause a timer or information flow connection to appear from the start icon with one end already connected to the icon. (The same connector could also be formed through use of the proper connection tool from tool palette 5003). The un-connected end of the appearing connector can then be “dragged” to connect with an eligible activity or timer icon. As noted with reference to FIG. 2B, connecting icons upon the screen interface directly corresponds to their associated objects being “related” to one another in the financial transfer object model. The delete button allows the user to delete the selected start icon. The resize button allows the user to modify the size of the icon. The text font allows a user to modify the text name associated with the start icon.

The name associated with the start icon corresponds to the name of the process (or financial transfer model) that is currently open in the financial transfer editor window. It should be recognized in the depicted embodiment that a process (or financial transfer model) has only one start icon. Finally, the specification command, which is present in the menus of each of the icons, allows a user to bring up a separate specification command window for defining particular attribute parameters associated with an icon's corresponding object instance. In this case, the start icon specification command allows parameters to be assigned to the start icon (and in turn, its root object instance). For a start icon, the user may simply specify the name of the icon along with any descriptive comments.

With reference to FIG. 5B, a non-financial transfer activity 5036 has been added to the depicted financial transfer model. In addition, an information flow connection 5037 has been used to connect the start icon 5030 to the non financial transfer icon 5036. The one-time financial transfer activity 5036 also has an associated menu, which in the depicted embodiment, has been activated through a right-click upon the non financial transfer activity icon. The non financial transfer activity menu includes similar commands to that of the start icon menu. These commands include a “create” command (with sub-commands for creating information flow, termination flow, timer connection and association connection relationships), a “delete” command, a “resize” command, a “text font” command, a “specification” command, and a “monitor settings” command. Most of these commands are the same as those previously discussed, and thus will not be described further. However, this menu also includes the additional monitor setting command, which allows the activity parameters relating to monitoring utilities, to be utilized on financial transfer models created by the financial transfer modeling program. In addition, the specification command for this activity will be addressed in greater detail herein due to the various parameters and settings that may be selected within it in connection with the non financial transfer activity.

FIG. 5C shows the two windows that are associated with the specification command for the non financial transfer activity icon. The first window, at 5040, appears when the attributes button, 5043, is selected. Conversely, when the other parameters button 5045 is selected, window 5047 appears. The attributes window, 5040, includes an attributes list panel 5042, along with a set of command buttons 5046, which allow, among other things, attributes to be added or removed. The other parameters window 5047 allows a user to specify various parameters associated with a selected non financial transfer activity.

The other parameters window includes a send email field, 5049; a time units menu selection field 5051; a mail recipient field 5053; and a recipients field or menu field 5048. These fields allow a user to specify recipients for receiving email messages that may be triggered upon predefined events occurring with respect to the selected non financial transfer activity. Window 5047 also includes a yellow state message field 5057, as well as a red state message field 5059. These fields allow the user to specify messages to be sent to email recipients in response to either yellow or red state events occurring in connection with the non financial transfer activity.

With the financial transfer modeling program of the depicted embodiment, non-financial transfer activities can be designated to go into either a yellow or a red state depending upon pre-specified conditions occurring within the model. Thus, with yellow and red state messages, designated email recipients can be notified when certain events or conditions are satisfied.

Finally, the other parameters window 5047 includes an others section, that comprises an access data interval menu field 5061, a time units field 5065 (which is associated with the data access menu field 5061), and a historical data interval menu field 5063. These fields allow the user to specify intervals upon which data is accessed from the non financial transfer activity. For example, simulation and/or monitoring routines would access data from the non financial transfer activity based on the specified intervals. The other parameters window 5047 also includes the standard command button set 5067, for allowing the user to act upon selections made within the window.

With respect to FIG. 5D, a non recurring financial transfer activity icon 5074 has been added to the depicted screen interface. It is connected to the start icon, with an information flow connection 5073. Also shown on the screen is the menu 5075 that appears when the user so activates (e.g., right clicks) the one-time financial transfer activity icon 5074. Also shown is the create menu submenu 5077, which includes available connections that may be used with the one-time financial transfer activity icon. These connections are information flow, terminate flow, timer connection, and association. These connections may only be used with certain pre-designated icon types. For example, in this embodiment, only a timer flow connector could be used to connect the one-time financial transfer icon 5074 to a timer icon. Likewise, association connections connect one-time (as well as re-occurring for that matter) icons to schedule icons, and information flow connectors connect the financial transfer activity icons to associated role icons. The main menu 5075 includes, apart from the create command, a delete command, resize command, a text font command, a specification command, and a monitor setting command.

The delete command allows the user to delete the icon; the text font command allows the user to modify the text associated with the icon; the specification command, when selected, causes a specification window to appear for allowing the user to specify various parameters associated with the one-time financial transfer activity icon 5074; and the monitor setting command allows the user to specify settings that will be used when the financial transfer model is being monitored. Again, most of these commands are fairly straightforward. However, the specification command will be addressed in greater detail since it invokes a unique specification window for each icon.

With reference to FIG. 5E, the various specification windows, 5082, 5098, and 5110, which selectively appear when the specification command has been selected, are depicted. The definition window, 5082 appears when the definition button 5083 is selected. Likewise, the parameter window 5098 appears upon selection of the parameter button 5085, and the transaction window 5110 appears upon selection of the transaction command button 5087. The definition window allows the user to generally define and/or describe the one-time financial transfer activity, e.g., for documentation purposes. The parameter window 5098 allows the user to define the payment parameters associated with the one-time financial transfer transaction. Finally, the transaction window 5110 allows the user to designate the specific transaction(s) occurring between the cash roles (not yet depicted) associated with the one-time financial transfer activity.

The definition window 5082 generally includes a name field 5089, a definition field 5091, a procedures field 5093, and a set of window command buttons 5095. The name field 5089 allows the user to enter a textual name corresponding to the one-time financial transfer icon. Similarly, the procedure field 5093 allows the user to enter a textual description of the procedure associated with the one-time financial transfer activity.

The parameters window 5098 generally includes a duration section 5099, and a priority designation menu window 5107. The duration section includes parameter fields for specifying durational parameters associated with the one-time financial transfer activities payment schedule. The priority menu field 5107 allows the user to specify a priority associated with the selected one-time financial transfer activity. Priorities are used in activity icons to enable simulation routines to reconcile activity conflicts when simulating financial transfer models. The duration section generally includes a default option 5099, a distribution option 5101, a value field 5103, and a unit field 5105 for the value field 5103.

When the default is selected, a pre-specified default value is used in order to determine when the transaction payment occurs in connection with the one-time financial transfer activity icon being activated. Conversely, if the default option is not selected, then the value specified in the value field 5103 is used for this duration.

The distribution field 5101 includes various statistical options including constant, uniform, normal, poisson, and exponential. Depending upon which option is selected, the specified value in field 5103 will be used or determined from a random selection based on the selected distribution type. That is, a statistical utility is incorporated that causes a value to be generated based on the designated distribution option. For example, if constant is selected, then the entered value would always be generated. On the other hand, if normal is selected, then a normal distribution will be imposed upon the generated value. That is, the designated value would be generated most of the time, but values deviating from it consistent with the normal distribution would also appear, proportional to their statistical likelihood.

This allows the user to model a real-world financial transfer activity using transaction occurrence parameters that match actual transaction occurrence windows. For example, if the one-time financial transfer activity corresponds to a one-time fee that is to be paid by a borrower, the fee may be due or paid within a certain window of time rather than on a particular date. Thus, it would not be certain when that payment would be received. Accordingly, the duration settings allow the financial transfer model to more accurately represent an actual set of financial transfer activities.

The transaction window 5110 generally includes a transaction name field 5111, a cash role from menu field 5114, an associated account field 5116, a cash role to menu field 5118, and its associated account field, 5120. The transaction window 5110 also includes schedule selection buttons 5113, along with an amount field 5122, and buttons for adding or removing transaction pages 5126.

The schedule selection options 5113 allow the user to either implement a schedule icon to be associated with the one-time financial transfer activity icon, or to designate the transaction solely within the one-time financial transfer activity icon. In the depicted embodiment, the latter option has been chosen. The “financial transfer from” menu field includes or allows the user to select (from a list of pre-designated cash roles) the cash role that is paying out money, while the “cash role to” field 5118, allows the user to select the financial transfer receiving the money.

The account fields 5116 and 5120 allow the user to designate pre-specified accounts for each of these roles. The amount field 5122 specifies the money amount to be transferred from the “from” cash role 5114 to the “to” cash role 5118. It should be noted that this amount field 5122 is only applicable when a schedule is not implemented with the given one-time financial transfer activity icon.

With reference to FIG. 5F, cash roles 5128 have been added to the one-time financial transfer activity icon 5074. Also depicted are the main menu 5130 and sub-menu 5132 that are associated with a cash role icon. It should be noted that at this point, the added cash roles 5128 are generic, i.e., they are not designated with specific cash role entities. The cash role command window 5130 generally includes a create command, a resize command, a delete command and a specification command. The create command, when selected, displays submenu 5132, which includes an association connection command. It can be seen with a cash role icon that the only connection that may be used is the association connection for connecting the cash role to a financial transfer activity icon.

The resize and delete options allow the user to resize and/or delete a generated cash role icon. The specification command when selected allows the user to open one or more specification windows that enable the user to specify parameters associated with the created cash roles.

With reference to FIG. 5G, the cash role specification window 5134 is shown. This window appears when the specification command is selected in the cash role command menu. The specification window generally includes a name list menu field 5136, an email field 5137, and the conventional command button set 5138.

The name menu field includes prespecified cash role entities that may be selected for a given cash role icon. The email field 5137 allows the user to associate a specific email address with a designated cash role entity. The command button set includes, OK, reset, apply, cancel and help buttons, which a user may select in connection with enabling a desired financial transfer entity from the cash role menu list 5136.

FIG. 5H shows the cash role icons 5128A and 5128B, which appear after specific cash role entities have been designated for the generic cash roles 5128. It can be seen that a plus sign appears in cash role icon 5128A, for payee number one; while a minus sign appears in cash role 5128B for payer 1. The plus sign conveys to a user that the cash role is receiving funds, and the minus sign conveys to the user that the cash role is paying out the funds.

With reference to FIG. 5I, a recurring financial transfer activity icon 5170 is added to the depicted model. Recurring financial transfer activity icon 5170 is connected to the start icon via an information flow connection 5171. A recurring financial transfer activity icon is used to represent and model financial transfer transaction(s) between payer and payee roles that occur on a substantially periodic basis. For example, it could be used for a mortgage payment, an interest allocation, a dividend payment, or the like.

Also shown is the menu 5173 associated with a recurring financial transfer activity icon. The recurring financial transfer activity menu 5173 generally includes a create command, a delete command, resize command, a text font command, a specification command and a monitor settings command. When the create command is selected, it causes a connections submenu 5174 to appear. This menu includes the connections that may be utilized with a recurring financial transfer activity. These connections are—and work the same as—those for the one-time financial transfer activity. They include an information flow, terminate flow, timer connection, and association connection. The information flow is used to connect the re-occurring financial transfer activity icon to other activity icons (except a timer icon), as well as to the start icon when so applicable. The timer connection is used to connect the recurring financial transfer icon to and from timer icons, which in turn, would typically be connected to other activity icons. The association connection is used to connect the recurring financial transfer activity to associated schedule and cash role icons.

The specification windows for the recurring financial transfer activity will not be presented, since they are the same as those used for the one-time financial transfer activity, except that the one-time financial transfer activity may or may not have an associated schedule, while the recurring financial transfer activity typically needs one. That is, with the depicted embodiment, one-time financial transfer activity transaction parameters may be defined by an associated schedule (via its payment/amortization schedules) or directly through its specification/transaction command window. Conversely, re-occurring financial transfer activities have their transaction parameters defined substantially by an associated schedule icon (object).

With reference to FIG. 5J, cash role icons 5176 have been added to the recurring financial transfer activity icon 5170. A schedule icon 5178 has also been added to the recurring financial transfer activity icon 5170. It can be seen that the lines connecting the recurring financial transfer icon 5170 to the cash roles 5176 and schedules 5178 are hashed. These hashed lines correspond to association connections, which again are used to connect cash roles and schedules to associated recurring or one-time financial transfer activity icons. Also depicted is a schedule icon menu 5179, which is associated with a schedule icon 5178. The schedule icon menu includes a create command, a resize command, a delete command and a specification command. Again, when the create command is selected, a connections submenu 5181 will appear. In this case, the only connection available is the association connection because only an association connection may be used with a schedule icon. The resize and delete commands allow the user to resize and/or delete the schedule icon. The specification command, when selected, causes a specification command window to appear, enabling the user to specify various parameters associated with the selected schedule.

With reference to FIG. 5K, an amortization window 5187, which appears when the amortization command is selected in the tools menu 405E, is shown. The amortization tool window 5187 is addressed here at this time because schedule icon parameters are primarily determined by their designated amortization schedule.

When the user initially selects the amortization command in the tool menu, window 5187 appears. The amortization window generally includes a new amortization schedule named field 5189, an available payment schedule menu field 5191, and an amortization schedule list field 5193. Named field 5189 allows the user to type or enter the name of a new amortization schedule to be defined. The payment schedule menu field 5191 includes a list of preexisting payment schedules that may be utilized for a designated (either newly created or previously specified) amortization schedule. The user selects one of these payment schedules within the payment schedule menu field 5191. The amortization schedule list 5193 includes the list of available amortization schedules that have been entered by the user. The window also includes a set of command buttons 5195, that allow the user to add, remove, replace or modify (build) the various amortization schedules.

With reference to FIG. 5L, the build window 5199 is shown. The build window 5199 appears when the user selects the “build” button within the set of command buttons 5195. The build button allows a user to define and formulate account column parameters for the selected amortization schedule. The build window 5199 includes a different set of command buttons 5201, one of which is an edit button that allows the user to edit a selected column type. It also includes commands that allow the user to define columns to be utilized. One of the defined column variables will be selected by the user in the schedule icon specification window for determining the money amount to be transferred between associated cash roles for a given transaction.

With reference to FIG. 5M, an edit window 5205 is shown. This window appears when the user selects the edit button from the set of available command buttons 5201 from the build window 5199. The edit window generally includes a name reference menu field 5207, a column name field 5203, a formula field 5211, an initial value field 5213, and a set of command buttons 5215. When a user wishes to create or define a new column variable, the name of the column is entered in the name field 5209.

The available name references will appear in menu field 5207. These name references correspond to payment variables from the selected payment schedule, which has been identified in the amortization window 5187. In this case, the payment schedule entitled, “Payment Two,” was selected.

The formula field 5211 defines the formula that is used to determine the column argument (or variable). This formula field 5211 may be edited by a user with conventional variable names, name reference names, and mathematical operators (e.g., +, −, /, *). The user can also use variable attributes such as the “.this” and “.pre” attributes for implementing, e.g., recursive and iterative algorithms, for performing such calculations as balance total and time-dependant amortization calculations. For example, a column variable for a current balance would be calculated based on present-time cash values added to the previously calculated balance. The initial value field 5213 is used to specify the initial money value associated with the defined column variable. The build window 5199 is shown again in screen 5203 in order to display the column that was created in the edit window 5205. This updated build window 5199 includes the column name, “current tool” 5217, and the formula 5219 associated with this current tool column.

With reference to FIG. 5N, the specification window 5221 is shown that appears when the specification command is selected within the menu associated with schedule icon 5178. This specification window includes an amortization schedule selection field 5223, and a description field 5225. The amortization schedule selection field 5223 includes a list of available amortization schedules already defined by the user. In the depicted embodiment, the amortization schedule, “payment 2,” which was previously defined, is selected. The description field 5225 allows the user to enter a textual description of the schedule 5178.

With reference to FIG. 5O, the specification windows for the recurring financial transfer activity icon 5170 are displayed. Like the one-time financial transfer activity windows, these windows include a definition window 5230, a parameter window 5245, and a transaction window 5257. The definition window appears when the user selects the definition button 5231. Likewise, the parameter window appears when the user selects the parameter button 5233, and the transaction window appears when the user selects the transaction button, 5235. The definition window includes a name field 5237, and a description field 5239, along with a procedure field 5241. The name field stores the name of the associated one-time financial transfer activity. The definition field and procedure fields 5239, 5241, allow the user to enter textual descriptions of the one-time financial transfer activity along with its associated procedures.

The parameters window 5245 generally includes duration fields and a priority menu field 5255. The duration fields include a default selection option 5247, a distribution menu field 5249, a value menu field 5251, and a units field 5253.

The default option, when selected, causes the activity to generate a predefined constant default duration for initiating the selected transaction associated with the one-time financial transfer activity. Conversely, when the default option 5247 is not selected, then the value field 5251 is used to determine how much time elapses from the initiation of the one-time financial transfer activity to the time that the transaction is to completed.

The distribution field 5249 allows the user to select either a constant, uniform, normal, Poisson, or exponential statistical distribution associated with the selected value from value field 5251. Finally, the unit field 5253 allows the user to define the time units associated with the value field 5251.

The transaction window 5257 includes a transaction name field 5235; a cash role FROM field 5263 with an associated account designation field 5264; a cash role TO field 5269 with an associated account designation field 5271; a schedule name designation field 5265; a column designation field 5267; an initial value field 5273; and ADD/DELETE page buttons 5275 and 5277, respectively.

As with the one-time financial transfer transaction window, the “cash role from” field 5263 allows the user to designate a cash role as the payor in the money transaction. Likewise, the “cash role to” field 5269 allows the user to designate a predefined cash role for receiving the money within the transaction.

The schedule designation field 5265 allows the user to select a predefined schedule activity icon, that is associated with the one-time financial transfer activity icon. The column designation field 5267 allows the user to designate a column from the amortization schedule associated with the schedule activity that has been selected. The initial value field 5273 allows the user to specify an initial value for the specified column. Finally, the “add” and “delete” page options 5275, 5277 allow the user to add or remove transaction pages.

It should be recognized that more than one schedule may be associated with a given recurring financial transfer activity icon. Therefore, the schedule name field 5265 allows the user to specify an associated schedule for a particular transaction. The add page button 5275 allows the user to add a separate transaction (with possibly separate cash roles and schedules) to the recurring financial transfer activity icon. The separate transaction could correspond to separate column variable values or separate accounts for which the same or different cash roles are paying and receiving.

With reference to FIG. 5P, a timer icon 5280 has been added to the depicted model. Also shown is a timer menu 5281, that is associated with the timer icon 5280. Timer icons allow a user to insert a specified amount of time delay between a source activity and one or more down-stream activities that are to be delayed in relation to the source activity. The timer icon menu 5281 includes a create command, a delete command, a resize command, and a specification command. The create command, when selected, causes a connection sub-menu 5283 to appear. The submenu includes available connections that must be used with a timer activity icon. These connections include the timer connection option and the terminate flow connection option.

With reference to FIG. 5Q, the windows that appear when the specification command is selected are shown. These windows include a definition window 5285, and a delay window 5297. The definition window appears when the user selects the definition button 5287. Likewise, the delay window 5287 appears when the user selects a delay button 5289. The definition window generally includes a name field 5291, and a definition field 5293. The name field receives the textual name of the timer icon, while the description field includes textual documentation for the timer icon.

The delay window 5297 generally includes a default option 5297, a distribution menu field 5299, a mean field 5301 and a standard deviation field 5305 (which appear when a normal or similar distribution in distribution field 5299 are selected) and a unit field 5303.

The default option, when selected, causes a default time delay to be associated with the timer icon. Conversely, when the default option is not selected, the mean or value field 5301 defines the time delay for the timer icon. In the depicted embodiment, a normal distribution has been selected in the distribution field 5299. This causes a mean, as opposed to a value field to appear at 5301. Here, the mean value is entered by the user with units that may be selected in Field 5303. A standard deviation associated with the specified distribution may also be designated at 5305.

With reference to FIG. 5R, the timer icon 5280 is shown connected between recurring financial transfer activity icon 5170, and newly added recurring financial transfer activity icon 5310, which has associated cash roles 5314A, B, and Schedule 5310. Timer icon 5280 imposes a delay, as specified in the previously addressed specification window, to occur from the time that transaction(s) for the recurring financial transfer activity 5170 occurs until the time that transaction(s) for the recurring financial transfer activity 5310 occur.

The basic icon and connector icons for the depicted embodiment have now been presented. With these basic components, users can create models for simple, as well as highly complicated, financial products. The icons and connectors impose uniformity and consistency as to how transactions and financial transfers are defined and represented. At the same time, they are adaptive and flexible enough to allow a user to accurately model almost any real-world financial system.

D. Completeness Checker

The completeness checker is a tool (or routine) within the financial transfer editor application component that when initiated, checks a constructed financial transfer model to determine whether it complies with previously specified rules. After launching the financial transfer modeling program, the user creates a new or opens a pre-existing financial transfer model. Once a model (or process) is opened, the user may select the completeness check command from the tools menu. The completeness check routine generally parses the financial transfer model, detects any violations of its predefined model construct rules, and displays a report window listing any rule violations. If there are no rules violations, the routine so indicates that there are no such errors.

In one embodiment when the financial transfer modeling program is implemented in an object oriented architecture, the financial transfer model is built by instantiating activity objects within a data structure such as a directed graph in order to build a financial transfer object model. Each object has attributes that have “and” or “or” characteristics. That is, each object has associated attributes that must or may be designated. For example, in the depicted embodiment, a re-occurring financial transfer activity object must have a payer and payee cash role, along with an associated schedule object. On the other hand, a non re-occurring financial transfer object must have payer and payee cash role objects, but it may or may not have an associated schedule object. Likewise, the other activity objects, along with the start object, have similar required relationships, which are inherently defined within their object class definitions within the financial transfer application component. With the instantiated activity objects being organized and connected to one another in a suitable data structure (e.g., directed graph), it then becomes relatively easy to implement a completeness check routine to efficiently traverse the data structure in order to determine whether each object is “complete” in terms of its instantiated relations.

FIG. 6A through 6E show one embodiment of a routine 600 for implementing a completeness check function of the present invention. Initially, at step 601 the routine checks all recurring and one-time financial transfer activity icons for unattached cash roles. At step 602, if it found any unattached cash roles, then it proceeds to step 604 where it writes the unattached role name to a completeness report data file 610, and from there proceeds to step 606. On the other hand, if at step 602 it was determined that no unattached cash roles exist, then the routine proceeds straight to step 606. At step 606, the routine parses all of the cash role names. From there it proceeds to 608, where it determines whether any cash roles went unnamed. If any cash roles are unnamed, it proceeds to step 612 and writes the unnamed role to the completeness report data file at 610 and proceeds to step 614. On the other hand if it found no unnamed cash roles at step 608, it proceeds directly to step 614, where it counts the number of cash roles for each financial transfer activity. From here at step 616 it determines whether or not the number of cash roles for each activity is equal to 2. If not, then at step 618 it writes the names of any financial transfer activities that have greater or less than two cash roles into the completeness report data file 610, and proceeds to step 620. On the other hand, at step 616, if it determined that every financial transfer activity has two cash roles, then it proceeds directly to step 620.

At step 620, the routine parses the directed graph model to identify a starter icon. If at step 622 it determines that no starter icon exists, then it writes that message into the completeness report data file 610, and proceeds to step 626, which is depicted on FIG. 6B. On the other hand if it determined that one and only one starter icon was present, then it proceeds directly to step 626.

At step 626, the routine counts the number of connections between the starter and all of its “related” (or connected) activities. If the number of connections is not greater than zero, then the routine proceeds to step 620, where it writes an insufficient starter connection message into the completeness data report file 610, and proceeds to step 632. On the other hand, if there are one or more connections from the starter icon to an activity, then the routine proceeds directly to step 632. At step 632, the routine reads every transaction within each financial transfer activity. At step 634, it determines whether the number of transactions for each activity is greater or equal to 1. If not, it writes an appropriate insufficient transaction message in the completeness report data file at step 636, and proceeds to step 638. On the other hand if it determined that every activity has at least one transaction, then it proceeds to step 638 directly.

At step 638, the routine parses the number of connections from each financial transfer activity to other activities, timers or starters. If the number of connections is equal to zero (i.e., the activity is unattached or hanging), then at step 642, the routine writes an improperly connected activity message into the completeness report data file 610, and proceeds to step 644, which is shown on FIG. 6C. On the other hand, if each activity has at least one connection to another activity, timer or starter, then the routine proceeds directly to step 644. At step 644, the routine counts the number of connections from each timer to either a starter or an activity. If this number is less than 2, than at step 646, the routine proceeds to step 648 and writes an improper timer connection error message into the completeness report data file 610 and proceeds to step 650.

Conversely, if it is determined that two connections are associated with each timer, then at step 646 the routine proceeds directly to step 650. (Note that the completeness check routine in the depicted embodiment can assume that any connection is proper because the continuously checking syntax check feature has already confirmed that it is proper, o there would be no connection.)

At step 650, for each schedule, the routine counts the number of connections to an associated activity. If the value is less than one, then the routine proceeds to step 654, and writes an improper schedule connection error message into the completeness report data file 610 and proceeds to step 656. Alternatively, if it is determined that each schedule has one connection to an associated activity, then the routine proceeds directly to step 656.

At step 656, the routine reads the names in each schedule. At step 658, it determines whether any schedules are unnamed. If it detects any unnamed schedules, it writes an unnamed schedule error message into the completeness report data file 610 at step 660, and proceeds to step 662.

On the other hand, at step 658 if it was determined that no unnamed schedules exist, then it proceeds directly to step 662. At step 662, the routine verifies, for each schedule connected to a financial transfer activity, that the activity designates the schedule option. If it is determined that the option is not selected at step 664, then it proceeds to step 666, where it writes an invalid schedule error message in the completeness report data file 610, and proceeds to step 668. On the other hand if it is determined that every schedule has an associated activity with an activated schedule option, then it proceeds directly to step 668, which appears on FIG. 6D.

At step 668, the routine counts the number of connected schedules for each recurring financial transfer activity. At step 670, it determines whether the number of connections is less than one. If so, then it proceeds to step 672, where it writes a required schedule error message in the completeness report data file, and proceeds to step 674. On the other hand if it was determined that each schedule is properly connected to its associated recurring financial transfer activity, then the routine proceeds directly to step 674. At step 674, the routine tests, for each recurring financial transfer activity's identified column to ensure that it is valid. At step 676 it determines whether any invalid columns were found. If so, the routine proceeds to step 678, where it writes an invalid column error message to the completeness report data file 610, and proceeds to step 680, which appears on FIG. 6E. Otherwise, if all columns are determined to be valid, the routine proceeds directly to step 680.

At step 680, the routine sorts the completeness report file 610, in order to prepare it for display to the user. Next it proceeds to step 682, where it reads the completeness report data file, and at step 684 determines whether the number of error messages in the report is equal to zero. If not, then the routine proceeds to step 686, where it writes an error statement for each error entry into a final report file 611. On the other hand, if at step 684 it determined that the completeness report data file 610 had no error messages, then it proceeds to step 687, where it writes “no errors” into the final completeness report file 611. From here, the final completeness report is displayed to the user at 613.

E. Example

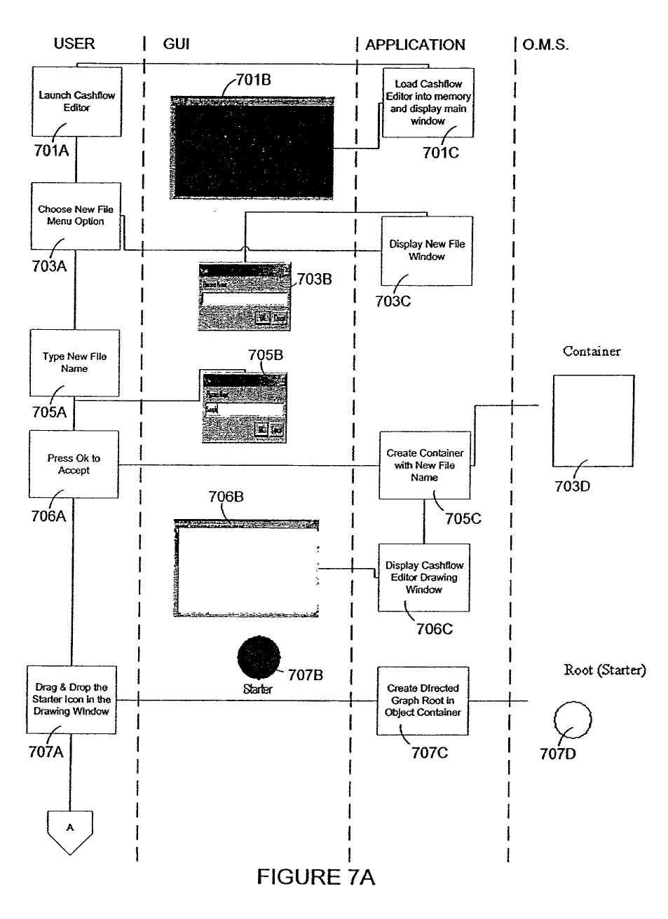

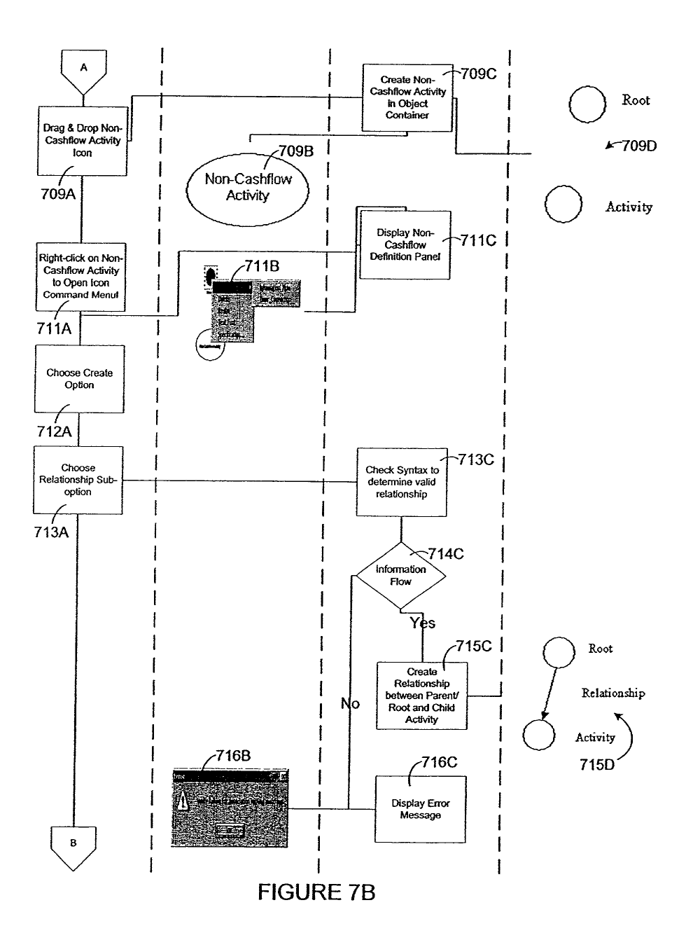

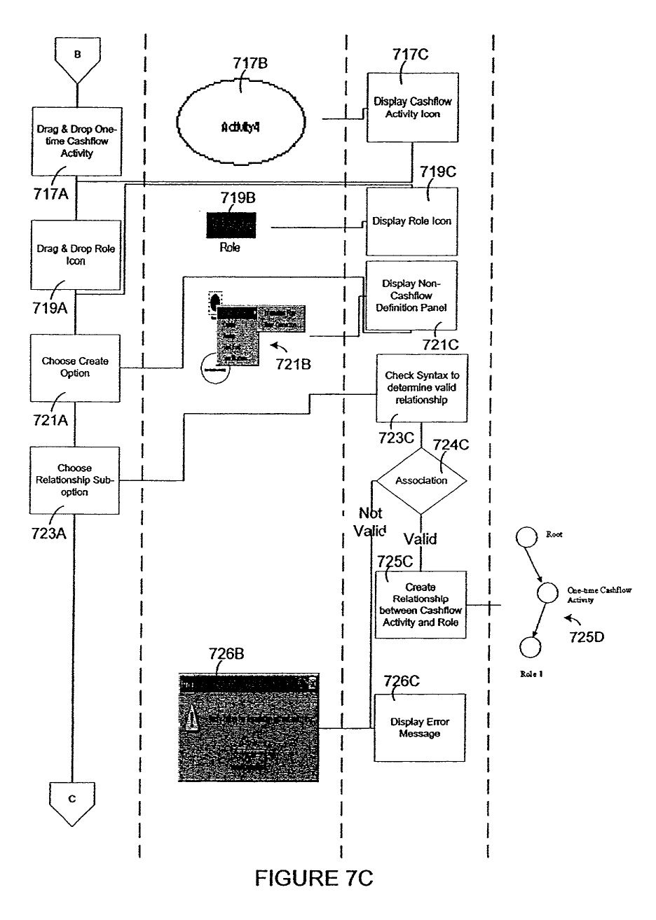

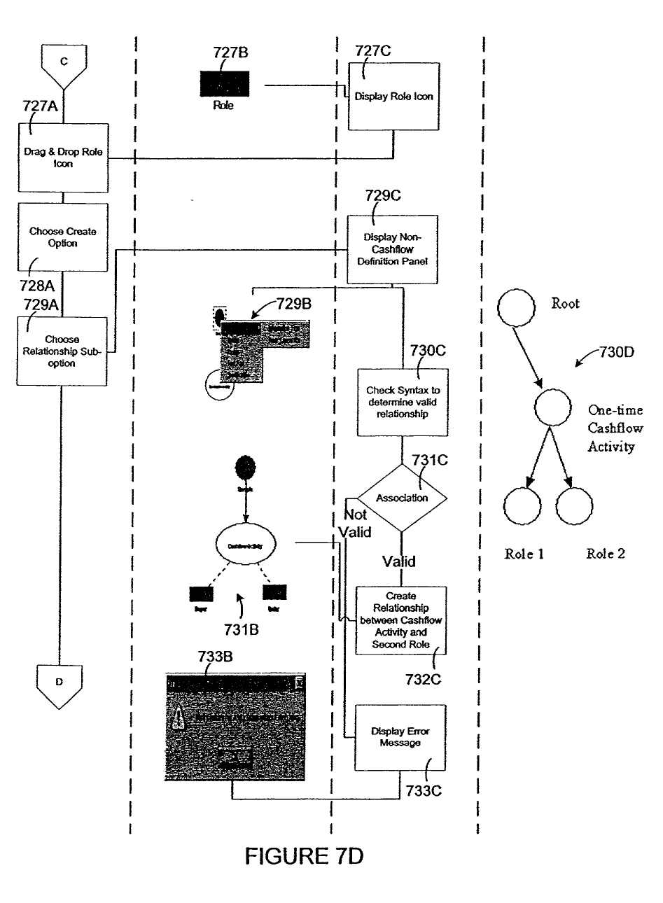

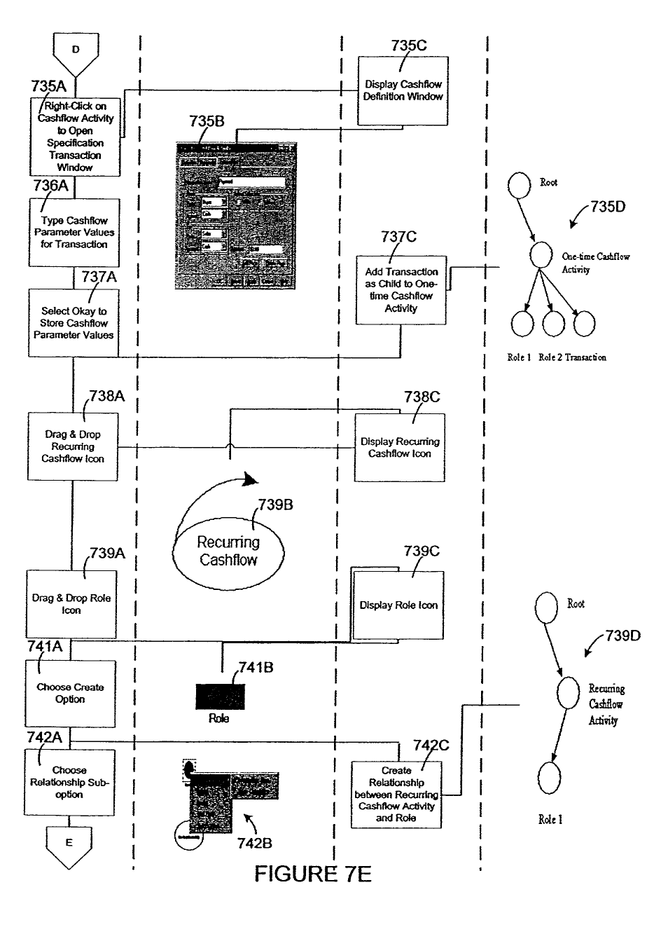

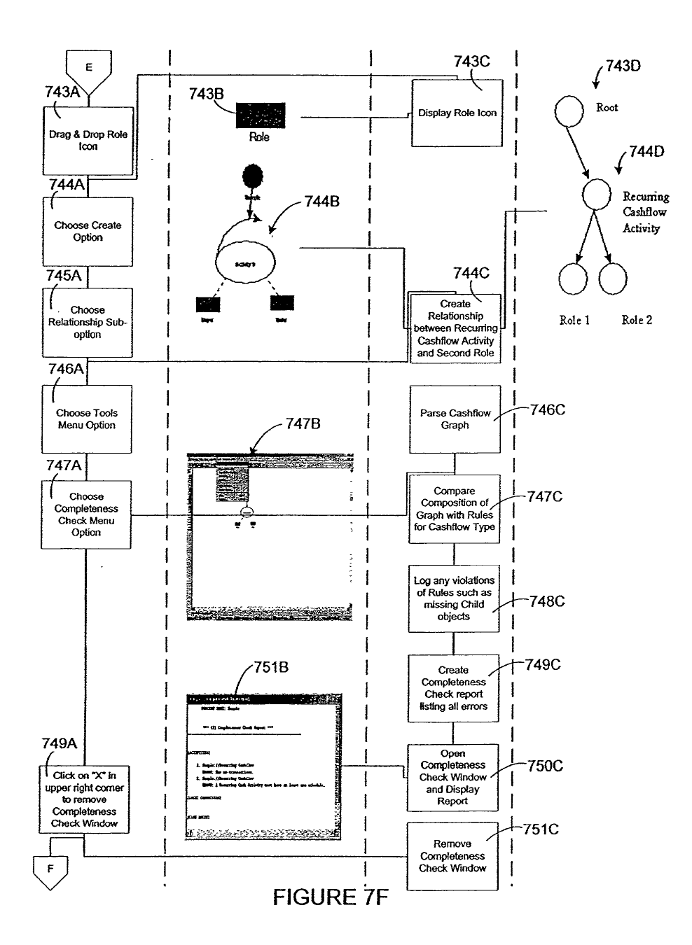

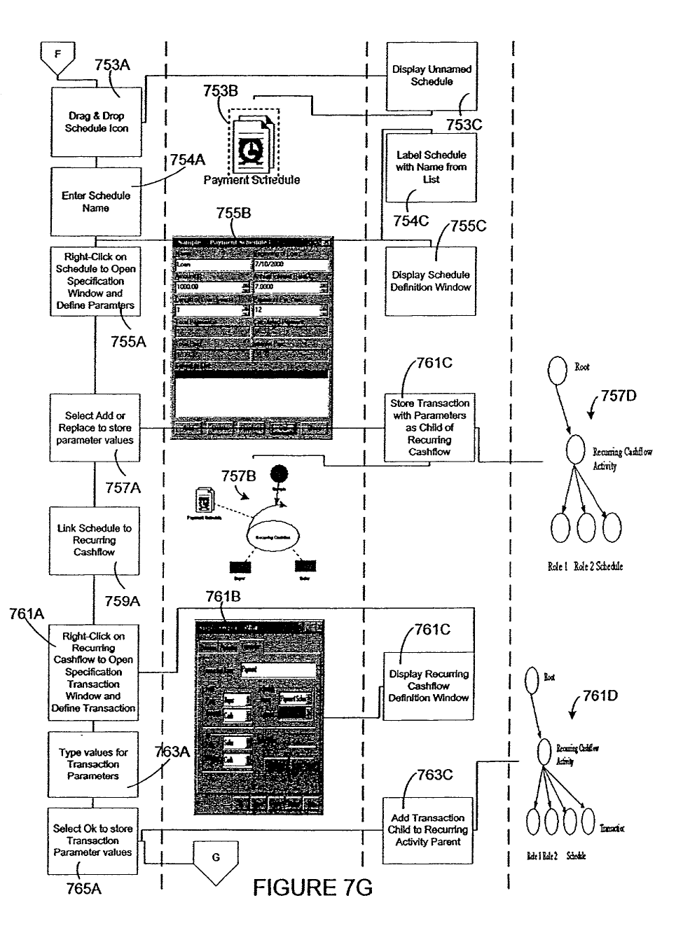

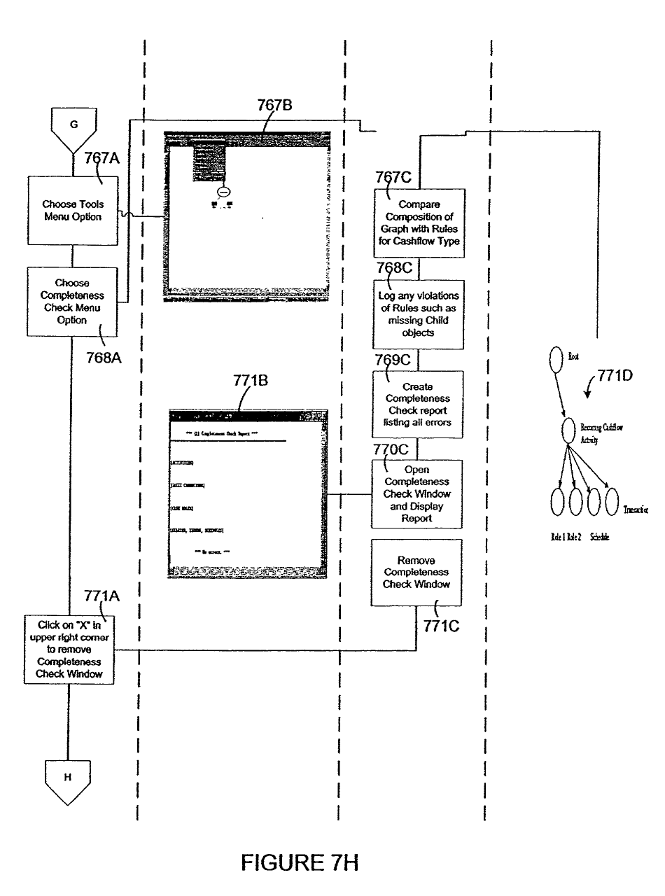

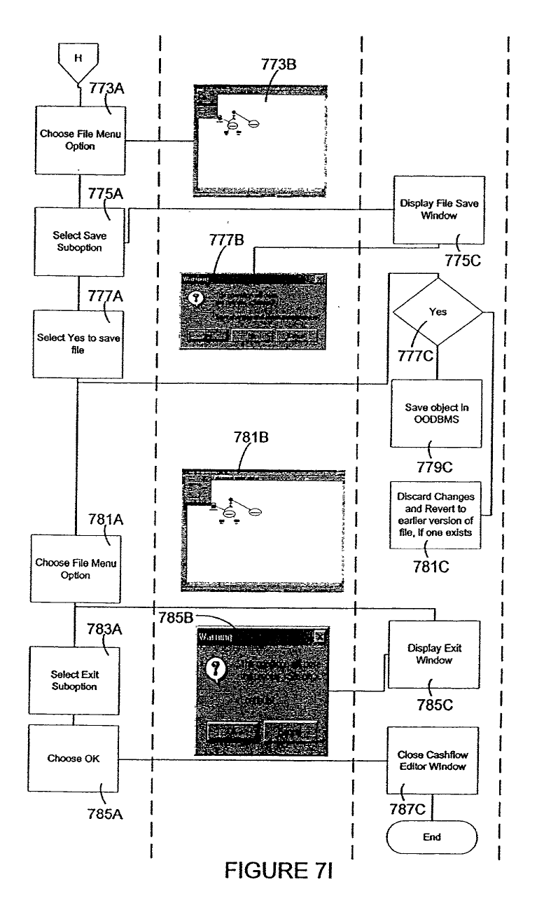

With reference to FIGS. 7A through 7I, a simple integrated example of a user constructing a financial transfer model through a financial transfer modeling program of the present invention will now be described. As shown in FIG. 7A, the graphical depiction is divided into four vertical columns. The left most column is the user column, which corresponds to an action taken by a user at a computer interface. The next column is the graphical user interface column which corresponds to what is being displayed on the screen interface in response to the user's action. The next column is the application column, which identifies the action implemented by the financial transfer application in response to the user's action through the graphical user interface. Finally, the last column is the object management system column, which graphically depicts the model being constructed within the object management system in response to instructions from the financial transfer application.

Initially, at 701A, the user launches the financial transfer modeling program. The screen interface shown at 701B would be present at this time. In response to this user command, the application component, at 701C, loads the financial transfer modeling program into memory and displays the main user interface for the financial transfer editor program. Next, at 703A, the user selects the new file option from the process menu. This is shown on the screen interface at 701B. This causes the application at 703C to display the new window in the user interface. At this point, nothing is yet to find for a model within the object management system.

Next, the user types the name of the new file at 705A and presses okay to create the new file at 706A. Upon receiving this command, the application creates a “container” space for the new file in the object management system at 703D. This application step is shown at 705C. In addition, at 706C, the application causes the screen interface to display the conventional financial transfer editor drawing window, which is shown at 706B. Next, at 707A, the user drags and drops a starter icon in the drawing window. This causes the application program at 707C, to create a directed graph rut in the object container, which is shown at 707D. In addition, the application also causes the starter icon to appear upon the screen interface at 707B. Next, at step 708A, the user drags and drops a non-financial transfer activity icon. This causes the application to create a non-financial transfer activity object instance, at step 709C, within the object container, which is graphically depicted at 709D. It also causes the non-financial transfer activity icon to be displayed upon the screen at 709B.

Next, at 711A, the user right clicks upon the non-financial transfer activity icon in order to open the definition panel within the non-financial transfer menu. This is shown upon the screen interface at 711B. The user chooses the “create” option at 712A and chooses the relationship sub-option at 713A. This causes the application at 713C, to determine whether the selected relationship comports with valid syntax rules. If the selected relationship is information flow at determination steps 714A, then the application causes the relationship to create an information flow relation between the parent (root) and non-financial transfer activity object instances. This is shown within the object management system at 715D. On the other hand, if a different relationship was selected, the application causes the screen to display an error message at 716C. This error message is shown within the screen interface at 716B.

Next, at step 717A, the user creates a one-time financial transfer activity. This causes the application at 717C to display the one-time financial transfer activity icon within the screen interface at 717B. At 719A, the user then drag and drops a roll icon which causes the application at 719C to display the role icon within the screen interface 719B. The user then chooses to create option at 721A which causes the application at 721C to display the non-financial transfer definition panel. This is shown at 721B. The user then chooses a relationship sub-option at 723A. This causes the application, once again, at 723C to check the syntax of the selected relationship to determine whether it is valid. At determination step 724C, if it is determined that it is an association relationship (which is valid) then the application creates the relationship within the object management system model between the one time financial transfer activity instance and the created first role instance at 725D. On the other hand, if a different relationship was selected, then the application at 726C causes the screen interface to display an error message, which is shown at 726B.

Next, at step 727A, the user drag and drops another role icon to complete the previously instantiated non-financial transfer activity object. This causes the application, at 727C, to display the role icon upon the screen interface at 727B. It also causes the role object instance to be defined within the object container (which is not shown). The user next chooses the create option at 728A, and selects a relationship sub-option at 729A. This causes the application at 729C to display the non financial transfer definition panel, which is shown at 729B.

At 730C, the application checks to determine whether the selected association is valid against predefined syntax rules. If it is determined at 731C that an association relation was selected, then at 732C, the application creates the association relationship between the non-financial transfer activity object and the substantiated second financial transfer object, which is shown within the object management system column at 730D. On the other hand, if it was determined that a different relationship was selected, then the application at 733C causes the screen interface to display an error message which is shown at 733B. Next, at 735A, the user right clicks upon the non-financial transfer activity icon in order to open up its menu and select the specification option at 735A. This causes the application at 735C to display the financial transfer definition window, which is shown at 735B. The user next types financial transfer parameter values for a transaction at 736A and selects “okay” to store the financial transfer parameter values at 737A. This causes the application to add the transaction parameters as a child to one time financial transfer activity object instance at step 737C. This is graphically depicted within the object management system column at 735D.

Next at 738A, the user drag and drops a recurring financial transfer icon upon the screen interface. This causes the application at 738C to display the recurring financial transfer icon, which is shown at 739B. This also causes the object instance to be defined within the object management system (which is not shown). Next, the user drag and drops upon the screen interface a role icon at step 739A. This causes the application to display the role icon at 739C, which is shown on the screen interface at 741B. At 741A, the user next right clicks upon the recurring financial transfer activity icon and selects the create option. Next at 742A, the user chooses a relationship sub-option. At this point, it is assumed that the user selects the correct “information flow” option, and thus, the syntax checking aspect within the application will not be shown. The application at 742C, creates the relationship between the first role and the recurring financial transfer activity instance. This is shown within the object management system column at 739D. Next, at step 743A, the user drag and drops a new second role icon. This causes the application at 743C to display the role icon upon the screen interface at 743B, and also to define a new role instance within the object container of the object management system.

At steps 744A through 746A, the user next selects association relationships from the recurring activity icon in order to relate the cash roles to the nonrecurring activity. This causes the application at 744C to create these relationships between the recurring financial transfer activity object and the cash roles. This is shown within the object management system at 744D, and upon the screen interface at 744B. Next, at 746A, the user chooses the tools menu option within the screen interface, and then, at 747A chooses the completeness checker command within the menu. This causes the application, at 746C, to invoke a completeness check routine, which begins by parsing the financial transfer object model graph. In implementing the completeness check, it then compares the composition of the graph object elements with predefined rules for the financial transfer type at 747C. At 748C, it logs any violations within an error file and at 749C, creates a completeness check report listing all errors. It then opens a completeness check window upon the screen interface and displays to the user the completeness check report at 750C. This is shown within the screen interface at 751B.

The user next, at 749A, clicks the X (close) option within the completeness check report window in order to remove it from the screen. This causes the application, at 751C, to remove the completeness check window. Next, at 753A, the user drag and drops a schedule icon upon the screen. This causes the application at 753C to display an unnamed schedule icon, which is shown at 753B. It also causes a schedule icon instance to be defined within the object container (not shown). The user next, at 754A, selects a schedule name from the list within the schedule definition panel upon right clicking and selecting a specification option. This causes the application, at 754C, to label the schedule with a name from the list. This is also shown at 753B. The user next, at 755A, enters scheduled parameter information within the schedule specification/parameter window. This causes the application to display the schedule definition window at 755A, and store the entered transaction parameters at 761 C. The displayed parameter window is shown on the screen interface at 755B.

The user next links the schedule to the recurring financial transfer activity at 759A. This causes the application to associate the schedule object instance with the recurring financial transfer activity object instance (not shown) which is displayed on the screen interface at 757B. This related schedule object instance is added to the object container model, as shown at 757D. Next, at 761A, the user right clicks upon the recurring financial transfer icon in order to define for it a transaction. This causes the application at 761C to display the recurring financial transfer definition window. It also causes the definition window to appear upon the screen interface at 761B. Next, the user types transaction values for the recurring financial transfer activity at 763A and selects okay for the stored transaction primer values at 765A. This causes the application to add the entered transaction parameters at 763C. The added parameters cause a transaction object instance to be associated with the recurring financial transfer activity object, as depicted at 761D.

Next, at 767A, the user chooses the tools menu once again, and selects the completeness check command at 768A. This causes the application to again parse and compare components within the directed graph to determine whether the inherent object rules have been violated for the particular financial transfer type. Any violations are logged within a report file at 768C, and a completeness check report is created at 769C. The application next opens a completeness check window and displays the reported errors within the window at 770C. This is shown within the screen interface at 771B. The user next selects the close option at 771A in order to close out of the completeness report window, which causes the application to so close this window. Next, at 773A, the user chooses the file menu option, and selects the save sub-option at 775A. This causes the application to display the file save window at 775C, which is shown on the screen interface 773B. The user next selects the yes option to save the file at 777A. The application, at 777C, determines that yes was selected and causes the financial transfer model within the object container to be saved within the object management system (object oriented database management system, at 779C). The user next chooses the file menu and selects the exit option at step 781A and 783A. It then chooses okay at 785A, which causes the application to display the exit window at 785C, and close the financial transfer editor window at 787C, which terminates execution of the financial transfer modeling program. These windows are shown upon the screen interface at 785B.

F. Remarks

A financial transfer modeling program of the present invention provides several advantages over conventional schemes, such as spreadsheet applications, for accounting and modeling complex financial systems. To begin with, it forces financial product developers to think of the product as an overall process rather than as a set of transactions. It also forces them to be explicit with underlying assumptions and defining parameters. These assumptions and parameters will then be readily apparent to others who may need to work with the product model. In contrast, product parameters contained within spreadsheet application models are typically convoluted and buried within the cells and underlying schema of the spreadsheet file.

Along these lines, with the present invention, financial products are modeled using tools and icon components that impose a certain amount of objectivity onto the model, which allows different people to be able to interpret it and work with it without the need for significant documentation or access to the designer. In addition, a financial transfer modeling program is easy to use—even for persons without expansive computer or financial backgrounds. When implemented, tools such as completeness and syntax checkers guide users into constructing a model that will be objectively valid, as compared against certain pre-defined criterion.

Furthermore, it can readily generate test data, which can be very useful for simulating products such as with Monte Carlo simulations. Moreover, the financial transfer modeling program is not only useful as a financial product design tool, but also, it can be highly valuable as an accounting tool with complicated financial systems. For example, it can be used to model chart of accounts tree structures. In this capacity, it can be extremely helpful in guiding users as to where transactions should be recorded. It allows complicated financial products and systems to have requisite controls that were heretofore not available. That is, it allows product developers to identify and redress control deficiencies. In turn, this allows companies to offer products that they otherwise could not offer because they could not reliably comply with accounting requirements for the product. In addition, users can use the program to infer risk and cost by looking at the history of similar financial transfers and by estimating delays and operational effort.

G. Other Embodiments

Although the present invention and its advantages have been described in detail, it should be understood that various changes, substitutions and alterations can be made herein without departing from the spirit and scope of the invention as defined by the appended claims. For example, a different graphical representation could be implemented instead of the interface primarily described above. In one different embodiment, a parametric interface using menus and input forms could be used to collect the same information from the user and produce a financial transfer model without allowing the interactive experimentation and incremental creation of a model.

In addition, a different syntax-based modeling language could be employed, e.g., algebraically or non-algebraically. An algebraic alternative could use a different data structure to describe financial transfers, which would result in different algebraic operations for checking syntax and simulating a model. Alternatively, a non-algebraic implementation could be built on top of a spreadsheet but would require much additional procedural logic to validate the formal correctness of a model because a spreadsheet cannot easily perform that function.

Moreover, numerous other suitable shapes, colors, and names could be used for the model objects and relationships. Along these lines, numerous other different sets of appropriate syntax rules could be defined and utilized.

Furthermore, instead of using an on-going syntax checking function, all the syntax rules could be applied to a model at one time, e.g., with the completeness checking routine. In such a scheme, a batch process could be substituted for online editing and immediate feedback.

Moreover, other types of data structures such as a binary tree or a linked list could be used in place of a directed graph. In addition, deviations from the exemplary financial transfer modeling user interface could be employed without departing from the invention. For example, various tool and icon specification functions could be presented in numerous other combinations of windows and tool commands.

In addition, the financial transfer modeling program of the present invention can be deployed in a wide range of computing environments. For example, it could be used as a standalone modeling tool on a personal computer or as part of a suite of software tools for financial product development. As a front-end to a computer software architecture platform for developing and processing financial products much faster than the current, prevalent software architectures, the financial transfer modeling editor can be an important attraction to potential customers. Furthermore, while the financial transfer editor is valuable as a product development tool, its value may even be much greater as part of an integrated workbench for managing financial product processing. In addition, it may be utilized in various settings including financial product development; budgeting for a household, company, or project; investment strategy preparation and evaluation; business modeling and planning; and financial analysis, such as discounting and net present value, to mention just a few.

Accordingly, the present invention has numerous possible embodiments and should not be limited to those specifically presented in this specification.

We claim as follows:

1. A computer implemented method for building a financial transfer model, comprising:
(a) presenting to a user a screen interface having a tool pallet with one or more icon tools and a workspace for creating a graphical representation of the financial transfer model, the one or more icon tools including at least one tool for generating financial transfer activity icon instances upon the workspace with each instance having at least one attribute for defining an associated transaction between a payer and a payee entity;
(b) receiving commands from the user for building upon the workspace the graphical representation of the financial transfer model including receiving commands for (i) generating one or more financial transfer activity icon instances upon the workspace (ii) associating at least one financial transfer transaction between a payer and a payee entity for each activity icon instance, and (iii) inter-connecting the one or more icon instances to generate the graphical financial transfer model; and
(c) conveying instructions to an application component responsive to receiving said user commands for defining a financial transfer model data structure that corresponds to the graphical financial transfer model.

2. The method of claim 1, wherein the act of providing a tool pallet with one or more financial transfer activity icon tools includes providing a recurring and a non recurring financial transfer activity icon tool.

3. The method of claim 1, wherein the act of providing a tool pallet includes providing a pallet with one or more tools for creating relational connections between financial transfer activity icon instances, said tools including information and timer flow tools for creating financial transfer and timing relationship connections.

4. The method of claim 3, wherein the act of providing a tool pallet includes providing a timer icon tool for creating a timer icon instance that can be configured between a first and second activity for creating a time delay relationship between said first and second activities.

5. The method of claim 1, wherein the financial transfer model data structure is created with object class instances corresponding to financial transfer activity icon instances defined by the user.

6. The method of claim 5, wherein the object instances are defined in a directed graph data structure.

7. The method of claim 6, wherein the act of providing a tool pallet includes providing a pallet with a start icon tool for generating a start icon instance for the beginning of the graphical financial transfer model, wherein the start icon instance corresponds to a root object instance in the directed graph data structure.

8. The method of claim 1, wherein the act of conveying instructions to an application component responsive to receiving said user commands for defining a financial transfer model data structure that corresponds to the graphical financial transfer model includes conveying said instructions to modify the data structure model if the received user commands comply with predefined syntax rules.

9. The method of claim 8, further comprising notifying the user that a received command for building the graphical financial transfer model is not allowed and not processing the command if the received command is not in compliance with the predefined syntax rules.

10. The method of claim 1, further comprising invoking a completeness checking routine to determine if the financial transfer data structure model is complete based on predefined criterion in response to a request from the user.

11. A memory storage media having machine-readable instructions for implementing a financial transfer editor program for building a financial transfer model, the instructions when executed causing a computer to perform a method comprising:
(a) presenting to a user a screen interface having a tool pallet with one or more icon tools and a workspace for creating a graphical representation of the financial transfer model, the one or more icon tools including at least one tool for generating financial transfer activity icon instances upon the workspace with each instance having at least one attribute for defining an associated transaction between a payer and a payee entity;
(b) receiving commands from the user for building upon the workspace the graphical representation of the financial transfer model including receiving commands for (i) generating one or more financial transfer activity icon instances upon the workspace (ii) associating at least one financial transfer transaction between a payer and a payee entity for each activity icon instance, and (iii) inter-connecting the one or more icon instances to generate the graphical financial transfer model; and
(c) responsive to receiving said user commands, defining a financial transfer model data structure that corresponds to the graphical financial transfer model.

12. The memory storage media of claim 11, wherein the act of providing a tool pallet with one or more financial transfer activity icon tools includes providing a recurring and a non recurring financial transfer activity icon tool.

13. The memory storage media of claim 11, wherein the act of providing a tool pallet includes providing a pallet with one or more tools for creating relational connections between financial transfer activity icon instances, said tools including information and timer flow tools for creating financial transfer and timing relationship connections.

14. The method of claim 11, wherein the financial transfer model data structure is created with object class instances corresponding to financial transfer activity icon instances defined by the user.

15. The memory storage media of claim 14, wherein the object instances are defined in a directed graph data structure.

16. The memory storage media of claim 15, wherein the act of providing a tool pallet includes providing a pallet with a start icon tool for generating a start icon instance for the beginning of the graphical financial transfer model, wherein the start icon instance corresponds to a root object instance in the directed graph data structure.

17. A memory storage media having machine-readable instructions for implementing a financial transfer editor program for building a financial transfer model, the instructions when executed causing a computer to perform a method comprising:
(a) presenting to a user one or more icon tools for creating a graphical representation of a financial transfer model, the one or more icon tools including at least one tool for generating a financial transfer activity icon instance with each instance having at least one attribute for defining an associated transaction between a payer and a payee entity;
(b) receiving commands from the user for building the graphical representation of the financial transfer model including receiving commands for (i) generating one or more financial transfer activity icon instances upon the workspace (ii) associating at least one financial transfer transaction between a payer and a payee entity, and (iii) inter-connecting the one or more icon instances to generate the graphical financial transfer model; and
(c) responsive to receiving said user commands, defining a financial transfer model data structure that corresponds to the graphical financial transfer model.

18. The memory storage media of claim 17, wherein the machine readable instructions include a plurality of instructions corresponding to a database management component that defines the financial transfer model data structure in response to the received commands from the user.

19. The memory storage media of claim 18, wherein the instructions comprise a plurality of instructions corresponding to a financial transfer modeling editor component that invokes the database management component to define the financial transfer model data structure in response to receiving the user commands via a plurality of instructions that correspond to a graphical user interface component.

20. The memory storage media of claim 18, wherein the database management component is an object oriented database application program.
